(19) United States
(12) Patent Application Publication
(10) Pub. No.: US 2016/0019013 A1
(43) Pub. Date: Jan. 21, 2016

(54) IMAGE FORMING APPARATUS AND NETWORK SYSTEM INCLUDING THE SAME

(71) Applicant: Sharp Kabushiki Kaisha, Osaka (JP)

(72) Inventor: Kazuhiko IDO, Osaka-shi (JP)

(21) Appl. No.: 14/800,853

(22) Filed: Jul. 16, 2015

(30) Foreign Application Priority Data
Jul. 17, 2014 (JP) 2014-146745
Oct. 28, 2014 (JP) 2014-219432

(51) Int. Cl. G06F 3/12

(52) U.S. Cl. CPC G06F 3/1268; G06F 3/1286

(57) ABSTRACT

An image forming apparatus stores permission information that identifies a network for which printing is permitted, and receives a print job from a terminal device via a network. If network information indicating a network to which the terminal device belongs is not included in the permission information, the image forming apparatus accepts an instruction as to whether or not to perform printing based on the print job. Upon accepting an instruction for printing the print job, the image forming apparatus stores the network information as the permission information and prints the print job. Upon accepting an instruction for prohibiting the printing of the print job, the image forming apparatus cancels the print job.

### BACKGROUND

1. Field

The present disclosure relates to image forming apparatuses capable of accepting print requests via networks, and more specifically to an image forming apparatus capable of appropriately processing a print request transmitted via a network from a user or a terminal device for which printing is prohibited, and a network system including the image forming apparatus.

2. Description of the Related Art

As one type of image processing devices serving as electronic devices, image forming apparatuses (typically, copying machines) for forming images on recording paper have been introduced into many business premises (such as companies and office blocks) in recent years. A multifunction peripheral (MFP), which is one type of such image forming apparatuses, has a plurality of functions including a copy mode, a facsimile mode, a communication network (hereinafter also referred to simply as a “network”) compatible printer mode, and a scanner mode.

In a network printing system, an image forming apparatus is connected to a network and is shared by a plurality of terminal devices (such as computers). That is, a user is able to cause the image forming apparatus to perform printing by using a terminal device connected to the network. The image forming apparatus receives a print job from the terminal device via the network, and forms an image on recording paper in accordance with the received print job.

The network printing system is a convenient system which allows a user to use an expensive MFP or the like even from a location remote from the place at which the MFP or the like is located. Depending on the settings of the system, however, a huge number of unwanted prints may be printed in accordance with a print request from a malicious person or in accordance with a print request made by mistake.

To address the issue described above, there is known a technique for registering users in advance who are permitted to use an image forming apparatus and authenticating a user to determine whether or not the user is permitted to use the image forming apparatus. For example, Japanese Unexamined Patent Application Publication No. 2007-156786 discloses an authentication system for a printing device for card authentication using an integrated circuit (IC) card to prevent unauthorized use by any unauthorized person and for stringent security checks to prevent even an authorized specific user from unauthorized use before it happens. In the disclosed system, an MFP connected to a network includes an IC card reader, and a management server connected to the network manages, for each piece of identification information (identifier) stored in an IC card, information on the content printed by the MFP (such as image data corresponding to the original of this print, a reference number specific to the image data, the title of the image data, and the date and time of printing).

The technique of the related art for limiting the use of an image forming apparatus connected to a network requires pre-registration of information concerning use limitation (for example, a user or a terminal device for which use is permitted), which is bothersome. There is also an issue in that the registered items need to be changed each time some changes such as personnel changes of users, organizational changes, or configurational changes of the network system occur, which makes management difficult.

There is also an issue in that, if the security based on user authentication is compromised one time and a print job is transmitted to the image forming apparatus, the print job is unconditionally printed. It is therefore desirable to prevent such an unauthorized use of the image forming apparatus. The technique disclosed in Japanese Unexamined Patent Application Publication No. 2007-156786 has difficulty in preventing such an unauthorized use.

### SUMMARY

Accordingly, it is desirable to provide an image forming apparatus capable of preventing inadvertent execution of a print job from a terminal device or a network for which printing is prohibited or from a user or a terminal device for which printing is prohibited, without pre-registration of permission of use, and capable of appropriately processing a print job from a terminal device or a network for which printing is prohibited, and also to provide a network system including the image forming apparatus.

According to a first aspect of the disclosure, there is provided an image forming apparatus including an image forming unit, a receiving unit, a determination unit, a storage unit, and an input unit. The image forming unit forms an image on recording paper. The receiving unit receives, from an external device, a print job and an address of the external device via a network. The determination unit determines whether or not formation of an image based on the print job by using the image forming unit is permitted. The storage unit stores permission information for identifying a permitted address representing an address of an external device for which formation of an image based on a print job by using the image forming unit is permitted. The determination unit determines whether or not formation of an image based on the print job by using the image forming unit is permitted, by determining whether or not the address of the external device, which is a source of the print job, matches the permitted address. In response to the determination unit determining that the address of the external device, which is the source of the print job, matches the permitted address, the image forming unit forms an image based on the print job. In response to the determination unit determining that the address of the external device, which is the source of the print job, does not match the permitted address, the input unit accepts an instruction as to whether or not to cause the image forming unit to form an image based on the print job. In response to the input unit having accepted an instruction for causing the image forming unit to form an image based on the print job, the image forming unit forms an image based on the print job.

According to a second aspect of the disclosure, there is provided an image forming apparatus including an image forming unit, a receiving unit, a determination unit, a storage unit, a network identifying unit, and an input unit. The image forming unit forms an image on recording paper. The receiving unit receives a print job from an external device via a network. The determination unit determines whether or not formation of an image based on the print job by using the image forming unit is permitted, in accordance with a network to which the external device belongs. The storage unit stores permission information which identifies a network for which formation of an image based on a print job by using the image forming unit is permitted. The network identifying unit identifies network identification information indicating a network to which the external device belongs. The determination unit determines whether or not formation of an image based on the print job by using the image forming unit is permitted, by determining whether or not the network identification information identified by the network identifying unit is included in the permission information. In response to the determination unit determining that the network identification information is included in the permission information, the image forming unit forms an image based on the print job. In response to the determination unit determining that the network identification information is not included in the permission information, the input unit accepts an instruction as to whether or not to cause the image forming unit to form an image based on the print job. In response to the input unit having accepted an instruction for causing the image forming unit to form an image based on the print job, the image forming unit forms an image based on the print job.

According to a third aspect of the disclosure, there is provided a network system including an image forming apparatus and a terminal device. The image forming apparatus and the terminal device are connected to a network. The image forming apparatus includes an image forming unit, a receiving unit, a determination unit, a storage unit, and an input unit. The image forming unit forms an image on recording paper. The receiving unit receives, from the terminal device, a print job and an address of the terminal device via the network. The determination unit determines whether or not formation of an image based on the print job by using the image forming unit is permitted. The storage unit stores permission information for identifying a permitted address representing an address of a terminal device for which formation of an image based on a print job by using the image forming unit is permitted. The determination unit determines whether or not formation of an image based on the print job by using the image forming unit is permitted, by determining whether or not the address of the terminal device, which is a source of the print job, matches the permitted address. In response to the determination unit determining that the address of the terminal device, which is the source of the print job, matches the permitted address, the image forming unit forms an image based on the print job. In response to the determination unit determining that the address of the terminal device, which is the source of the print job, does not match the permitted address, the input unit accepts an instruction as to whether or not to cause the image forming unit to form an image based on the print job. In response to the input unit having accepted an instruction for causing the image forming unit to form an image based on the print job, the image forming unit forms an image based on the print job.

According to a fourth aspect of the disclosure, there is provided a network system including an image forming apparatus and a terminal device. The image forming apparatus and the terminal device are connected to a network. The image forming apparatus includes an image forming unit, a receiving unit, a determination unit, a storage unit, a network identifying unit, and an input unit. The image forming unit forms an image on recording paper. The receiving unit receives a print job from the terminal device via the network. The determination unit determines whether or not formation of an image based on the print job by using the image forming unit is permitted, in accordance with a network to which the terminal device belongs. The storage unit stores permission information which identifies a network for which formation of an image based on a print job by using the image forming unit is permitted. The network identifying unit identifies network identification information indicating a network to which the terminal device belongs. The determination unit determines whether or not formation of an image based on the print job by using the image forming unit is permitted, by determining whether or not the network identification information identified by the network identifying unit is included in the permission information. In response to the determination unit determining that the network identification information is included in the permission information, the image forming unit forms an image based on the print job. In response to the determination unit determining that the network identification information is not included in the permission information, the input unit accepts an instruction as to whether or not to cause the image forming unit to form an image based on the print job. In response to the input unit having accepted an instruction for causing the image forming unit to form an image based on the print job, the image forming unit forms an image based on the print job.

### BRIEF DESCRIPTION OF THE DRAWINGS

FIG. 1 is a block diagram illustrating a configuration of a network printing system according to first and fourth embodiments of the present disclosure;

FIG. 2 is a block diagram illustrating a configuration of an image forming apparatus included in the network printing system illustrated in FIG. 1;

FIG. 3 is a block diagram illustrating a configuration of a terminal device included in the network printing system illustrated in FIG. 1;

FIG. 4 is a block diagram illustrating a configuration of a server computer included in the network printing system illustrated in FIG. 1;

FIG. 5 is a flowchart illustrating a print request program executed by the terminal device illustrated in FIG. 3;

FIG. 6 is a flowchart illustrating a print processing program executed by the image forming apparatus illustrated in FIG. 2;

FIG. 7 is a diagram illustrating a screen displayed on a display unit of a terminal device for which printing is prohibited;

FIG. 8 is a diagram illustrating a screen displayed on an operation unit of the image forming apparatus in response to receipt of a print job from a terminal device for which printing is prohibited;

FIG. 9 is a diagram illustrating a screen displayed on the server computer;

FIG. 10 is a diagram illustrating a screen displayed on a display unit of a terminal device for which printing is not permitted;

FIG. 11 is a flowchart illustrating a print processing program executed by an image forming apparatus included in a network printing system according to a second embodiment of the present disclosure;

FIG. 12 is a diagram illustrating a screen displayed on a display unit of a terminal device for which printing is prohibited;

FIG. 13 is a diagram illustrating a screen displayed on an operation unit of the image forming apparatus in response to receipt of a print job from a terminal device for which printing is prohibited;

FIG. 14 is a diagram illustrating a screen displayed on a server computer;

FIG. 15 is a diagram illustrating a screen displayed on the operation unit of the image forming apparatus after an administrator login has been created;

FIG. 16 is a flowchart illustrating a print processing program executed by an image forming apparatus included in a network printing system according to a third embodiment of the present disclosure;

FIG. 17 is a diagram illustrating a screen displayed on a display unit of a terminal device for which printing is prohibited;

FIG. 18 is a diagram illustrating a screen displayed on an operation unit of the image forming apparatus in response to receipt of a print job from a terminal device for which printing is prohibited;

FIG. 19 is a flowchart illustrating a printing availability selection program executed by a server computer included in the network printing system according to the third embodiment of the present disclosure;

FIG. 20 is a diagram illustrating a screen displayed on the server computer;

FIG. 21 is a flowchart illustrating a print request program executed by the terminal device illustrated in FIG. 3 according to the fourth embodiment of the present disclosure;

FIG. 22 is a flowchart illustrating a print processing program executed by the image forming apparatus illustrated in FIG. 2 according to the fourth embodiment of the present disclosure;

FIG. 23 is a diagram illustrating a screen displayed on a display unit of a terminal device currently used by a user for which printing is prohibited;

FIG. 24 is a diagram illustrating a screen displayed on an operation unit of the image forming apparatus in response to receipt of a print job from a terminal device currently used by a user for which printing is prohibited;

FIG. 25 is a diagram illustrating a screen displayed on the server computer;

FIG. 26 is a diagram illustrating a screen displayed on a display unit of a terminal device currently used by a user for which printing is not permitted;

FIG. 27 is a flowchart illustrating a print processing program executed by an image forming apparatus included in a network printing system according to a fifth embodiment of the present disclosure;

FIG. 28 is a diagram illustrating a screen displayed on a display unit of a terminal device currently used by a user for which printing is prohibited;

FIG. 29 is a diagram illustrating a screen displayed on an operation unit of the image forming apparatus in response to receipt of a print job from a terminal device currently used by a user for which printing is prohibited;

FIG. 30 is diagram illustrating a screen displayed on a server computer;

FIG. 31 is a diagram illustrating a screen displayed on an operation unit of the image forming apparatus after an administrator login has been created;

FIG. 32 is a flowchart illustrating a print processing program executed by an image forming apparatus included in a network printing system according to a sixth embodiment of the present disclosure;

FIG. 33 is a diagram illustrating a screen displayed on a display unit of a terminal device currently used by a user for which printing is prohibited;

FIG. 34 is a diagram illustrating a screen displayed on an operation unit of the image forming apparatus in response to receipt of a print job from a terminal device currently used by a user for which printing is prohibited; and

FIG. 35 is a diagram illustrating a screen displayed on a server computer.

### DESCRIPTION OF THE EMBODIMENTS

In the following embodiments, the same or substantially the same components are given the same reference numerals. The same applies to the names and functions of such components. Such components will not be redundantly described in detail.

In the following description, the term “network address” refers to the address of a network itself, and the address (for example, the Internet protocol (IP) address) of each host (such as a computer) connected to the network on the network is referred to simply as an “address”. For example, a network address is an IP address with a host portion that is all zeros.

### First Embodiment

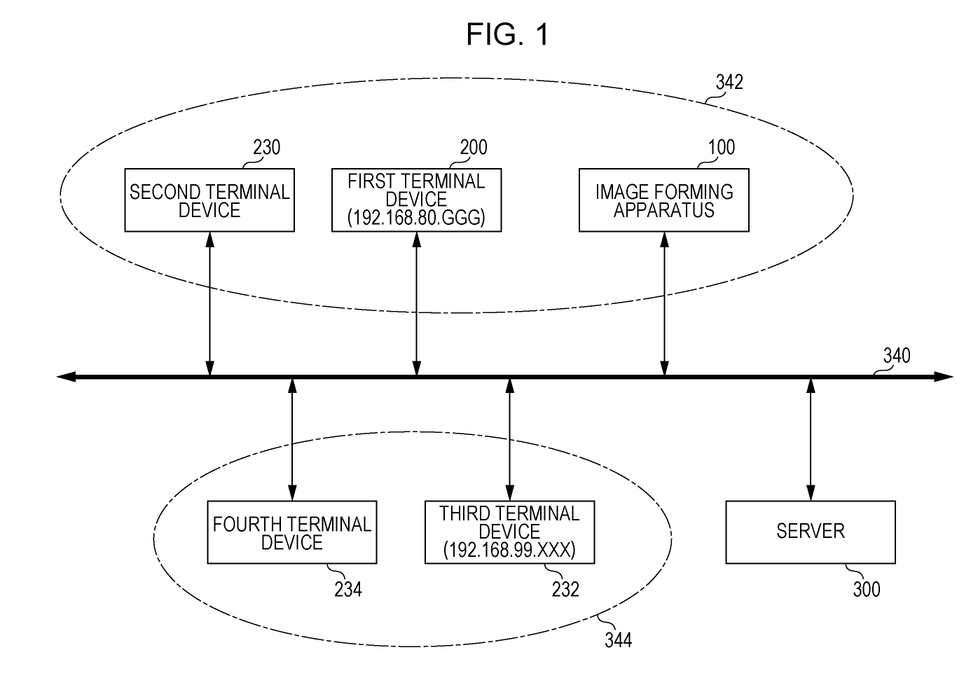

Referring to FIG. 1, a network printing system according to a first embodiment includes an image forming apparatus 100 connected to a network 340, a plurality of terminal devices such as computers, and a server computer (hereinafter also referred to simply as a “server”) 300. In FIG. 1, the plurality of terminal devices are a first terminal device 200, a second terminal device 230, a third terminal device 232, and a fourth terminal device 234. Other terminal devices may be connected to the network 340. Furthermore, an image forming apparatus other than the image forming apparatus 100 may be connected to the network 340.

The network 340 is, for example, a local area network (LAN). While the network 340 is indicated by a single line in FIG. 1, the network 340 may be configured such that a plurality of network cables are connected using a relay device such as a router or a gateway (both of which are not illustrated in the drawings). The network 340 may be connected to a public network such as the Internet.

The network 340 illustrated in FIG. 1 is managed as one or more segments by the server 300. Here, by way of example, the communication protocol is Transmission Control Protocol/Internet Protocol (TCP/IP). In the server 300, a well-known program is executed and a well-known database is managed in order to enable communication among terminal devices connected to the network 340. Each of the terminal devices connected to the network 340 belongs to one of two segments in accordance with the address (IP address) set for the terminal device. That is, the image forming apparatus 100, the first terminal device 200, and the second terminal device 230 belong to a first segment 342, and the third terminal device 232 and the fourth terminal device 234 belong to a second segment 344. The network address of the first segment 342 is, for example, 192.168.80.0/24 (with a network portion of 24 bits and a host portion of 8 bits), and the network address of the second segment 344 is 192.168.99.0/24 (with a network portion of 24 bits and a host portion of 8 bits). The notation of the network addresses is based on Classless Inter-Domain Routing (CIDR), and a prefix after the slash (/) symbol specifies the number of bits of the network portion.

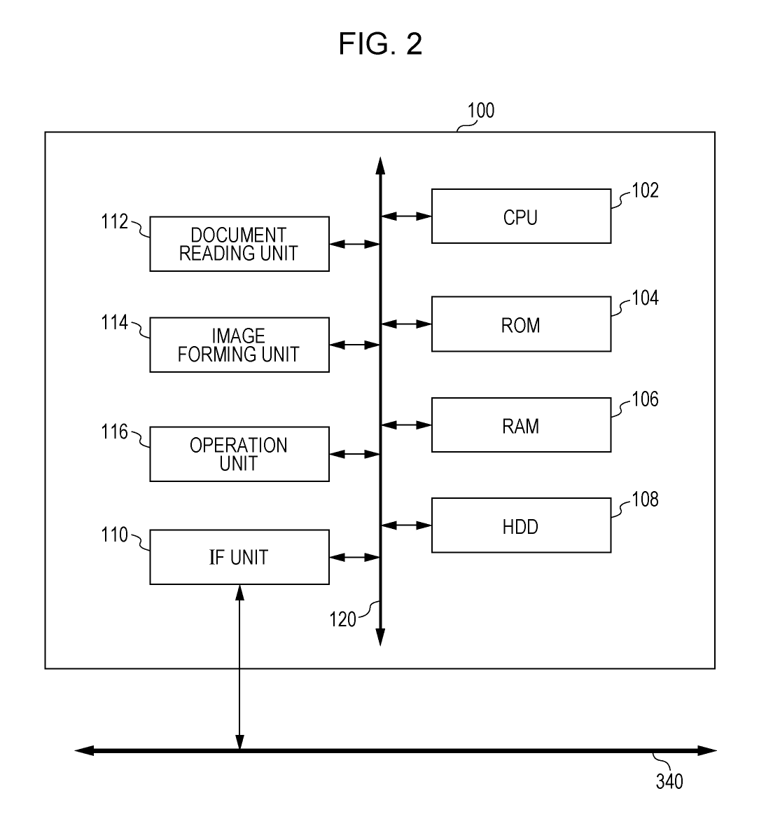

The image forming apparatus 100 is, for example, an MFP having functions such as a copy function and a printer function. Referring to FIG. 2, the image forming apparatus 100 includes a central processing unit (CPU) 102 that controls the overall operation of the image forming apparatus 100, a read-only memory (ROM) 104 for storing a program and the like, a random access memory (RAM) 106 that is a volatile storage device, and a hard disk drive (HDD) 108 that is a non-volatile storage device for holding data even if power supply is disconnected. The ROM 104 stores a program and data necessary to control the operation of the image forming apparatus 100.

The image forming apparatus 100 includes an interface (IF) unit 110, a document reading unit 112, an image forming unit 114, an operation unit 116, and a bus 120. The image forming apparatus 100 further includes a paper feeding unit, a recording paper conveying unit, and a paper discharge tray (all of which are not illustrated in the drawings).

The components described above are connected to the bus 120, and data (including control information) is exchanged among the components via the bus 120. For example, the CPU 102 reads a program onto the RAM 106 from the ROM 104 via the bus 120, and executes the program using part of the RAM 106 as a working area. That is, the CPU 102 controls the components constituting the image forming apparatus 100 in accordance with the program stored in the ROM 104, and implements the individual functions of the image forming apparatus 100.

The document reading unit 112 reads a document by using, for example, a charge-coupled device (CCD) to generate image data. The image data is temporarily stored in the RAM 106. The image forming unit 114 forms (or prints) an image on a sheet of recording paper which is conveyed by the recording paper conveying unit from the paper feeding unit, in accordance with the image data stored in the RAM 106.

The operation unit 116 includes an input unit and a display unit. For example, the operation unit 116 may be a touch panel display. In this case, the display unit may be a display panel such as a liquid crystal panel, and the input unit may be a touch panel disposed on the display panel and configured to detect a touched position. A screen is displayed on the display unit of the operation unit 116 to give instructions to the image forming apparatus 100. A user is able to give instructions to, for example, set and perform the functions of the image forming apparatus 100 by selecting a key displayed on the display unit through the input unit, which is superimposed on the display unit (e.g., by touching the corresponding portion on the touch panel).

For example, in a case where the user gives instructions to copy a document, as described above, a document set on the document reading unit 112 is scanned to generate image data, and an image based on the generated image data is formed on a sheet of recording paper picked up from the paper feeding unit. The sheet of recording paper on which the image has been formed is discharged to the paper discharge tray.

The IF unit 110 is an interface connected to the network 340 to allow the image forming apparatus 100 to communicate with an external device via the network 340. Examples of the IF unit 110 include a network interface card (NIC). Accordingly, the image forming apparatus 100 receives a print job from a terminal device, and forms an image on recording paper in accordance with the print job.

The image forming apparatus 100 may include a modem and may be connected to a telephone line via the modem. The connection of the image forming apparatus 100 to the telephone line enables the user to transmit image data obtained by scanning of a document via facsimile (FAX) over the telephone line.

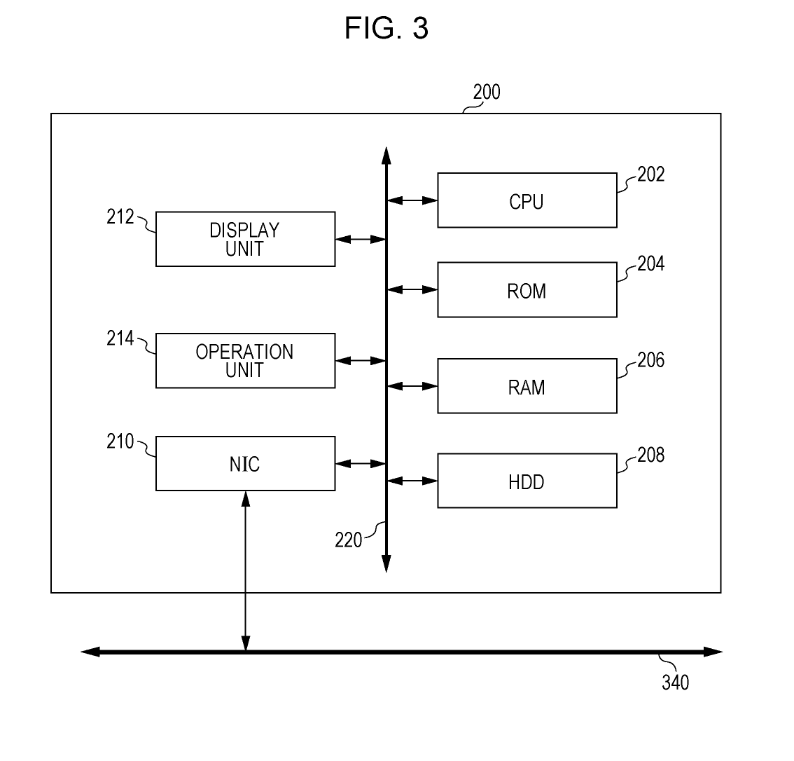

The first terminal device 200, the second terminal device 230, the third terminal device 232, and the fourth terminal device 234 are well-known computers, for example. Referring to FIG. 3, the first terminal device 200 includes a CPU 202, a ROM 204, a RAM 206, an HDD 208, an NIC 210, a display unit 212, an operation unit 214, and a bus 220 to which the CPU 202, the ROM 204, the RAM 206, the HDD 208, the NIC 210, the display unit 212, and the operation unit 214 are connected. The second terminal device 230, the third terminal device 232, and the fourth terminal device 234 also have a similar configuration.

The NIC 210 is an interface connected to the network 340 to allow the first terminal device 200 to communicate with an external device via the network 340.

The display unit 212 includes a display device (such as a liquid crystal display device or a cathode-ray tube (CRT) display device) capable of displaying an image, and a video output device that supplies a video signal to the display device. The video output device generates a video signal to be supplied to the display device by using image data stored in a video RAM (VRAM) (for example, a predetermined area in the RAM 206). The operation unit 214 is a device for inputting instructions to the first terminal device 200, and includes, for example, a computer keyboard and a computer mouse.

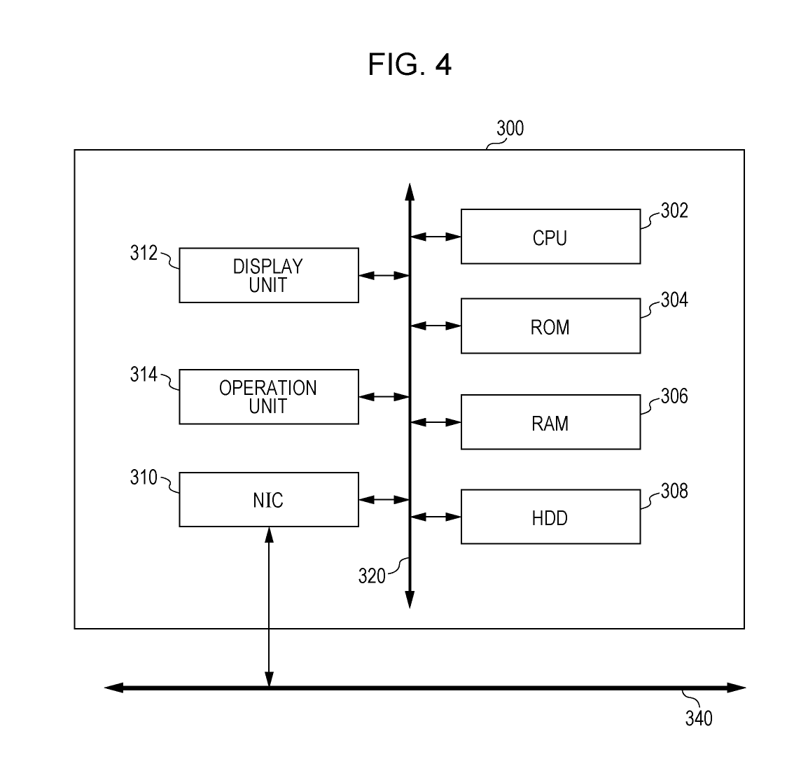

Referring to FIG. 4, the server 300 is a well-known computer, and includes a CPU 302, a ROM 304, a RAM 306, an HDD 308, an NIC 310, a display unit 312, an operation unit 314, and a bus 320 to which the CPU 302, the ROM 304, the RAM 306, the HDD 308, the NIC 310, the display unit 312, and the operation unit 314 are connected. The NIC 310 is an interface connected to the network 340 to allow the server 300 to communicate with an external device via the network 340. The display unit 312 is a display device capable of displaying an image, and has a configuration similar to the display unit 212 of the first terminal device 200. The operation unit 314 is a device for inputting instructions to the server 300, and has a configuration similar to the operation unit 214 of the first terminal device 200.

In the following, a print service provided by the network printing system illustrated in FIG. 1 will be described. It is assumed that the image forming apparatus 100 has a print permission list in which information (for example, network addresses) that identifies networks for which printing is permitted (networks from which the formation of images based on print jobs is permitted) is registered in advance. The print permission list is stored in the HDD 108. Upon receipt of a print job via the network 340, the image forming apparatus 100 performs printing if a terminal device that has transmitted the print job belongs to any of the registered networks (any or the networks identified by the network addresses). Otherwise, the image forming apparatus 100 suspends printing.

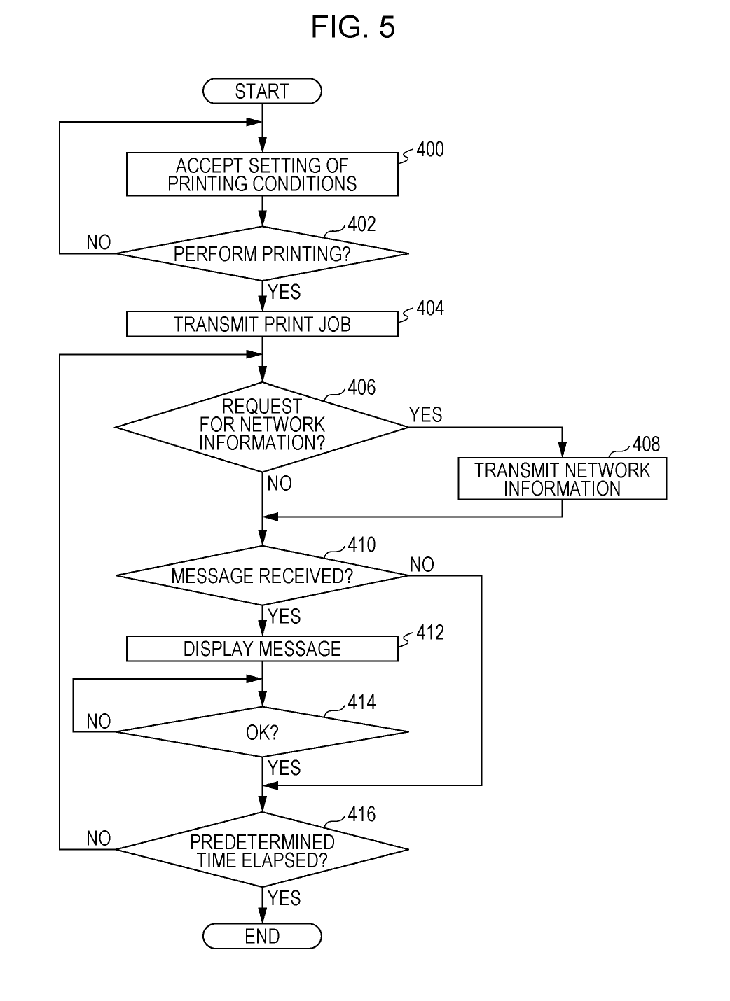

Referring to FIG. 5, in step 400 of a print request program executed by the first terminal device 200, the CPU 202 accepts the setting of printing conditions. The setting of printing conditions is enabled by, for example, a user starting a predetermined application with designation of a certain file and providing printing instructions. The user can operate the operation unit 214 to input printing conditions to a screen displayed by a printer driver installed in the first terminal device 200. In this case, if the first terminal device 200 has installed therein printer drivers for multiple image forming apparatuses, one of the image forming apparatuses is selected. It is assumed here that the image forming apparatus 100 has been selected. The input printing conditions are stored in the RAM 206.

In step 402, the CPU 202 determines whether or not instructions for performing printing have been made. For example, the CPU 202 determines that instructions for performing printing have been made if an “OK” button is pressed on the screen displayed by the printer driver. If it is determined that instructions for performing printing have been made, the control proceeds to step 404. Otherwise, the control returns to step 400.

In step 404, the CPU 202 generates a print job in accordance with the printing conditions set in step 400, and transmits the print job to the image forming apparatus 100 selected in step 400 via the NIC 210. The print job is transmitted in the form of packets, and each packet has a communication header in which the IP address of the image forming apparatus 100 is set as a destination address and the IP address of the first terminal device 200 is set as a source address. The communication header includes well-known additional information based on TCP/IP. For example, the communication header includes the Media Access Control (MAC) addresses of the image forming apparatus 100 and the first terminal device 200, and information (such as identification, flags, and fragment offset) indicating the order of transmission of the packets to enable the destination device (i.e., the image forming apparatus 100) to reconfigure the original data (print job) from the plurality of transmitted packets.

When the transmission of the print job is completed, the CPU 202 obtains information indicating the current time (hereinafter also referred to as the “current time”) from a timer (not illustrated in FIG. 3), and stores the current time in the RAM 206 as the start time.

In step 406, the CPU 202 determines whether or not a request for transmission of network information has been received from the image forming apparatus 100. The network information is information for identifying a network, and is, for example, a subnet mask. If it is determined that a request for transmission of network information has been received, the control proceeds to step 408. Otherwise, the control proceeds to step 410. Whether or not the received data is data transmitted from the image forming apparatus 100 can be determined based on whether or not the source IP address included in the received packet data is the IP address of the image forming apparatus 100.

In step 408, the CPU 202 transmits network information on the network (i.e., the first segment 342) to which the first terminal device 200 belongs. The network information on the first segment 342 is information for allowing the image forming apparatus 100 to identify the first segment 342, and is, for example, the subnet mask (for example, 255.255.255.0) held in the first terminal device 200. The source IP address in the request for transmission of network information, which is received in step 406, is used as the destination IP address.

In step 410, the CPU 202 determines whether or not a message described below has been received from the image forming apparatus 100. If it is determined that a message has been received, the control proceeds to step 412. Otherwise, the control proceeds to step 416.

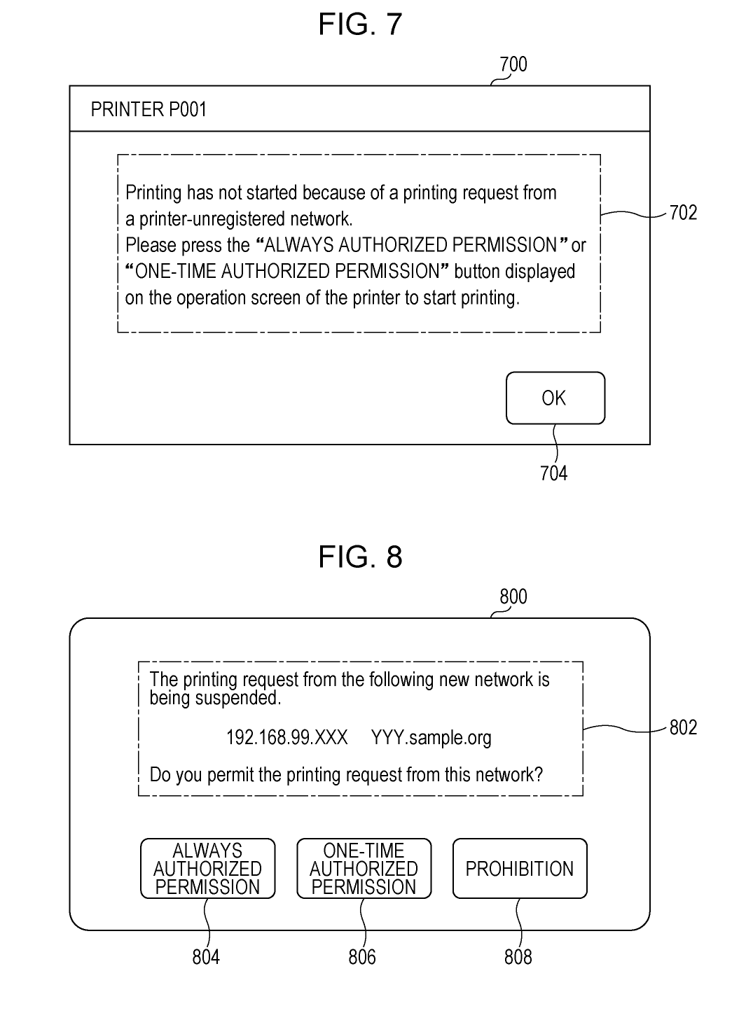

In step 412, the CPU 202 displays the message received in step 410 on the display unit 212. For example, a screen 700 illustrated in FIG. 7 is displayed. The screen 700 has an area 702 in which the message (text data) received from the image forming apparatus 100 is displayed.

In step 414, the CPU 202 determines whether or not an OK button 704 has been selected through the operation unit 214. If it is determined that the OK button 704 has been selected, the control proceeds to step 416. Otherwise, the processing of step 414 is repeatedly performed.

In step 416, the CPU 202 determines whether or not a predetermined time period has elapsed since the transmission of the print job. Specifically, the CPU 202 obtains the current time from the timer, reads the start time stored in the RAM 206 in step 404, and determines whether or not a predetermined time period has elapsed since the start time. If it is determined that the predetermined time period has elapsed, the program ends. Otherwise, the control returns to step 406. An appropriate time period during which a message described below can be received from the image forming apparatus 100 may be set as the predetermined time period.

Accordingly, after transmitting a print job, the first terminal device 200 waits for a message from the image forming apparatus 100, which is the destination of the print job, for a predetermined time period. Each time a message is received within the predetermined time period, the content of the message is displayed on the display unit 212.

The second terminal device 230, the third terminal device 232, and the fourth terminal device 234 also execute a similar print request program.

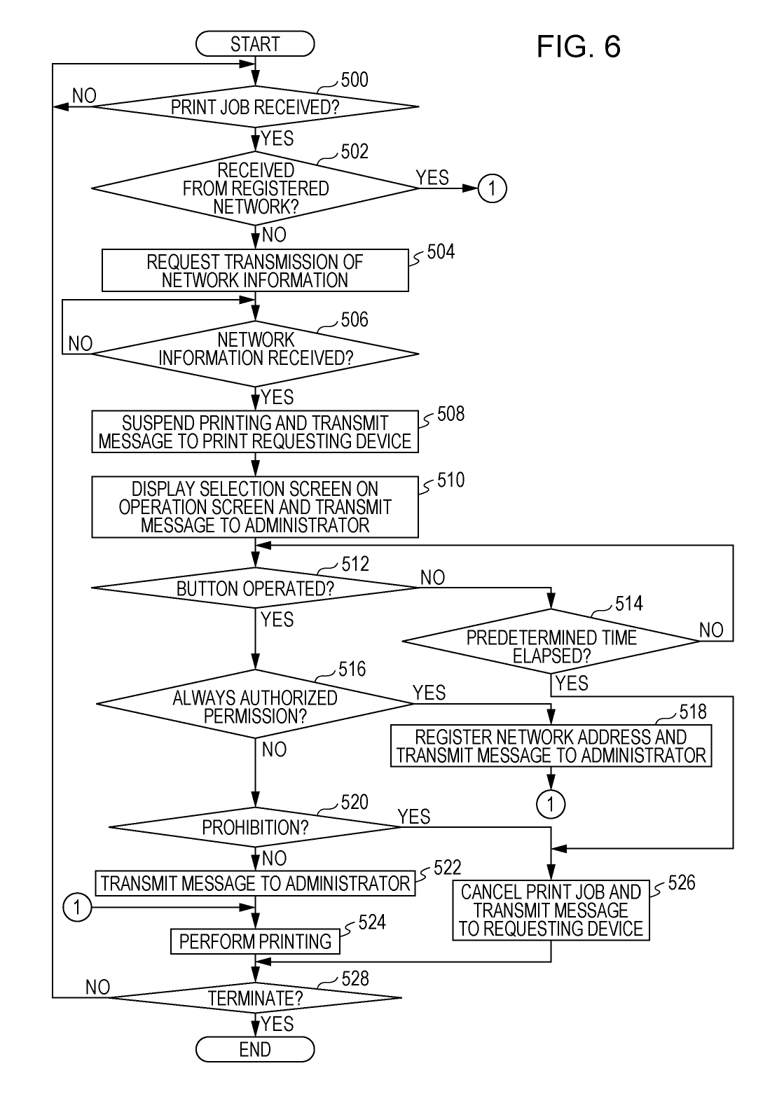

Referring to FIG. 6, a print processing program executed by the image forming apparatus 100 will be described. In step 500, the CPU 102 determines whether or not a print job has been received. If it is determined that a print job has been received, the control proceeds to step 502. Otherwise, the processing of step 500 is repeatedly performed. The CPU 102 stores the received print job in the RAM 106 or the HDD 108. Since the print job is transmitted in the form of packet data, the CPU 102 stores the source IP address included in the received packets in the RAM 106 as information identifying a device which has transmitted the print job.

In step 502, the CPU 102 determines whether or not the print job received in step 500 has been received from a network (hereinafter also referred to as a “registered network”) identified by a network address registered in the print permission list. Specifically, the CPU 102 determines whether or not the source IP address stored in the RAM 106 in the step 500 matches any of a plurality of IP addresses identified by respective network addresses registered in the print permission list. If any IP address is matched, it is determined that the print job has been received from a registered network. For example, the print permission list has registered therein the network address 192.168.80.0/24. In this case, if a print job has been received from a terminal device having an IP address within the range of 192.168.80.1 to 192.168.80.254, it is determined that the print job has been received from a registered network. If it is determined that the print job has been received from a registered network, the control proceeds to step 524. Otherwise, the control proceeds to step 504.

In step 504, the CPU 102 requests the device that has transmitted the print job to transmit network information. Specifically, the CPU 102 transmits a network information transmission request command using the source IP address stored in the RAM 106 in step 500 as the destination IP address.

In step 506, the CPU 102 determines whether or not network information has been received from the device requested to transmit network information. Whether or not network information has been received from the device requested to transmit network information is determined based on whether or not a source IP address included in the received packets matches the source IP address stored in the RAM 106 in step 500. The network information to be received is the information transmitted in step 408 in FIG. 5, that is, the subnet mask on the terminal device that has transmitted the print job. If it is determined that network information has been received, the CPU 102 determines a network address. Then, the control proceeds to step 508. Otherwise, the processing of step 506 is repeatedly performed.

The CPU 102 identifies the network portion of the source IP address stored in the RAM 106 in step 500 by using the received subnet mask. Accordingly, a network address is determined. Specifically, the CPU 102 calculates the logical AND of the two bit strings.

For example, the subnet mask is 255.255.255.0 (with a network portion of 24 bits). In this case, if the source IP address is 192.168.80.GGG (e.g., the first terminal device 200), the network address is 192.168.80.0/24, which specifies the first segment 342 to which the first terminal device 200 belongs. If the source IP address is 192.168.99.XXX (e.g., the third terminal device 232), the network address is 192.168.99.0/24, which specifies the second segment 344 to which the third terminal device 232 belongs.

In step 508, the CPU 102 suspends the execution of the print job received in step 500, and transmits a message indicating the suspension of printing to the device that has transmitted the print job because the print request is sent from an unregistered network. The CPU 102 transmits data (such as image data or text data) indicating the message using the source IP address stored in the RAM 106 in step 500 as the destination IP address. The transmitted message is received by the terminal device that has transmitted the print job (step 410 in FIG. 5) and is displayed (step 412). Accordingly, for example, the screen 700 illustrated in FIG. 7 is displayed on the terminal device that has transmitted the print job.

In step 510, the CPU 102 transmits, to the administrator computer (i.e., the server 300), a message indicating the reception of a print request from an unregistered network, and displays a selection screen on the operation unit 116. Specifically, a screen 800 illustrated in FIG. 8 is displayed. The screen 800 has an area 802 in which a message indicating the suspension of the execution of the print job is displayed, and buttons 804, 806, and 808 below the area 802 for selecting how the print job is to be processed. After displaying the screen 800, the CPU 102 obtains the current time from the timer (not illustrated in FIG. 2), and stores the current time in the RAM 106 as the start time. The transmitted message is displayed on the administrator computer.

In step 512, the CPU 102 determines whether or not any of the buttons 804, 806, and 808 displayed on the screen 800 illustrated in FIG. 8 has been operated (or selected). If it is determined that any button has been operated, the CPU 102 makes the screen 800 disappear, and then the control proceeds to step 516. Otherwise, the control proceeds to step 514.

In step 514, the CPU 102 determines whether or not a predetermined time period has elapsed since the screen was displayed on the operation unit 116 in step 510. Specifically, the CPU 102 obtains the current time from the timer, reads the start time stored in the RAM 106 in step 510, and determines whether or not a predetermined time period has elapsed since the start time. If it is determined that the predetermined time period has elapsed, the CPU 102 makes the screen 800 disappear, and then the control proceeds to step 526. Otherwise, the control returns to step 512.

In step 516, the CPU 102 determines whether or not the button determined in step 512 to have been operated is the “Always Authorized Permission” button 804. If it is determined that the button is the “Always Authorized Permission” button 804, the control proceeds to step 518. Otherwise, the control proceeds to step 520.

In step 518, the CPU 102 registers the network address determined in step 506 to the print permission list (stores the network address in the HDD 108), and transmits a message indicating the registration of the network address to the administrator computer (i.e., the server 300). Then, the control proceeds to step 524.

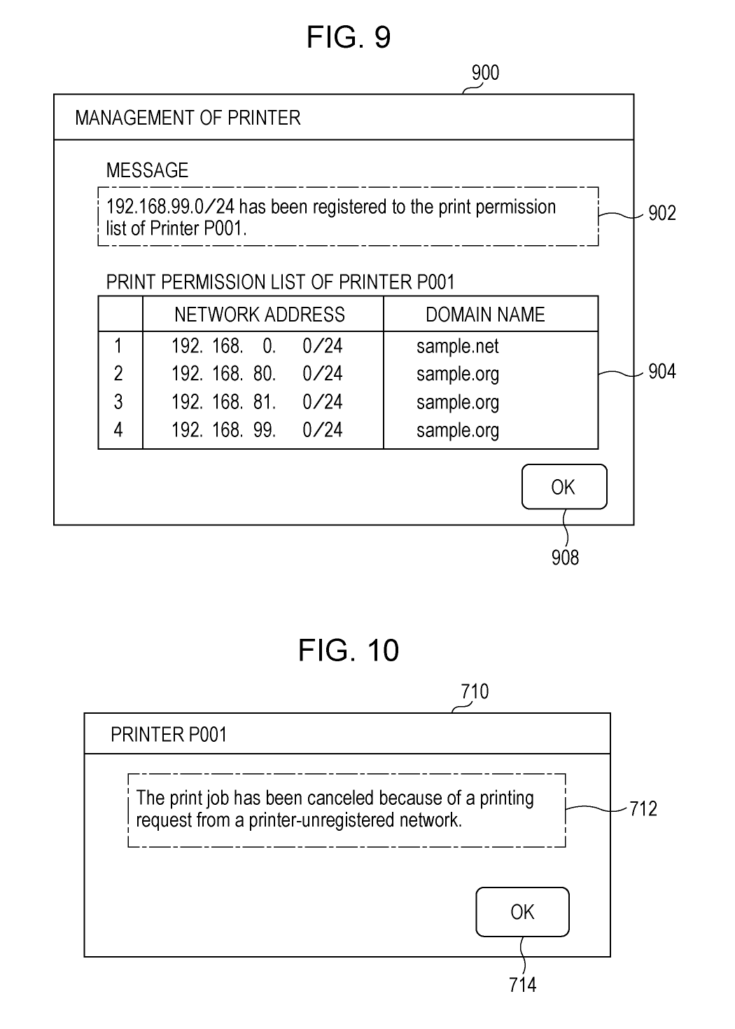

For example, a screen 900 illustrated in FIG. 9 is displayed on the server 300. The screen 900 has an area 902 in which a message including information (P001) identifying the printer (i.e., the image forming apparatus 100) and indicating that a new network address has been registered to the printer is displayed. A table 904 shows network addresses currently registered in the printer in association with the information (P001) identifying the printer, which is included in the message. The newly registered network address is shown in the bottom row of the table 904. The server 300 holds information for providing a network connection service, and can thus determine, based on the source IP address included in the packets of the message transmitted in step 518, information identifying the corresponding one of the printers (such as the name of the printer). If an OK button 908 is selected, the screen 900 disappears.

If NO is determined in step 516, in step 520, the CPU 102 determines whether or not the button determined in step 512 to have been operated is the “Prohibition” button 808. If it is determined that the button is the “Prohibition” button 808, the control proceeds to step 526. Otherwise, the control proceeds to step 522.

In step 522, the CPU 102 transmits, to the administrator computer (i.e., the server 300), a message indicating that printing has been permitted just this once in response to a print request from an unregistered network.

In step 524, the CPU 102 executes the print job received in step 500.

In step 526, the CPU 102 cancels or discards the print job received in step 500 (or deletes the print job from the RAM 106 or the HDD 108), and transmits a message indicating the cancellation of the transmitted print job to the source of the print job. The source IP address stored in the RAM 106 in step 500 is used as the destination IP address. Accordingly, a screen 710 illustrated in FIG. 10 is displayed on the terminal device that has transmitted the print job through the processing of steps 410 and 412 in FIG. 5. The screen 710 has an area 712 in which the received message is displayed. If an OK button 714 is selected, the screen 710 disappears.

In step 528, the CPU 102 determines whether or not instructions for terminating the program have been received. If it is determined that instructions for terminating the program have been received, the program ends. Otherwise, the control returns to step 500. The termination instructions are made by, for example, turning off the power of the image forming apparatus 100.

Accordingly, upon receipt of a print job from a terminal device belonging to a network not registered in the print permission list (NO in step 502), the image forming apparatus 100 can suspend the print job and perform processing in accordance with instructions. If always authorized permission is selected (YES in step 516), the image forming apparatus 100 registers the corresponding network address to the print permission list (step 518), and performs printing in accordance with the print job (step 524). If printing is prohibited (YES in step 520), the image forming apparatus 100 cancels the received print job (step 526). If printing is permitted just this once as an exception (NO in step 520), the image forming apparatus 100 performs printing in accordance with the print job (step 524) although the corresponding network address is not registered to the print permission list.

When the screen 700 (FIG. 7) is displayed on a terminal device immediately after the user gives printing instructions by using the terminal device, the user goes to the image forming apparatus 100 and operates a button on the screen 800 (FIG. 8) so that printing can be performed. If the user has given printing instructions by mistake, the user can select the “Prohibition” button 808 to stop printing.

In the case of a print request from outside the organization that manages the image forming apparatus 100 (for example, in the case where instructions for printing a huge number of prints have been issued with malicious intent), a person who has made the print request will not be able to operate the screen 800 displayed on the image forming apparatus 100 and the print job is canceled with the lapse of a predetermined time period, thereby preventing the execution of unwanted printing. Since a message is also transmitted to the administrator computer (step 510), the execution of unwanted printing can also be prevented by the administrator's selection of the “Prohibition” button 808.

Pre-registration in the print permission list is not necessarily required. The selection of the “Always Authorized Permission” button 804 on the displayed screen 800 facilitates the registration of a network for which printing is permitted, if necessary.

### Second Embodiment

In the first embodiment, a user who has transmitted a print request can select the “Always Authorized Permission” button. In a second embodiment, in contrast, only a specific person such as an administrator can select the “Always Authorized Permission” button.

A network printing system according to this embodiment, and an image forming apparatus, terminal devices, and a server that constitute the network printing system have a configuration similar to that of the first embodiment (FIGS. 1 to 4). A terminal device according to this embodiment executes a program similar to that (FIG. 5) in the first embodiment. A print processing program executed by the image forming apparatus is different from that in the first embodiment. In the following, reference is made to the reference numerals in FIGS. 1 to 5.

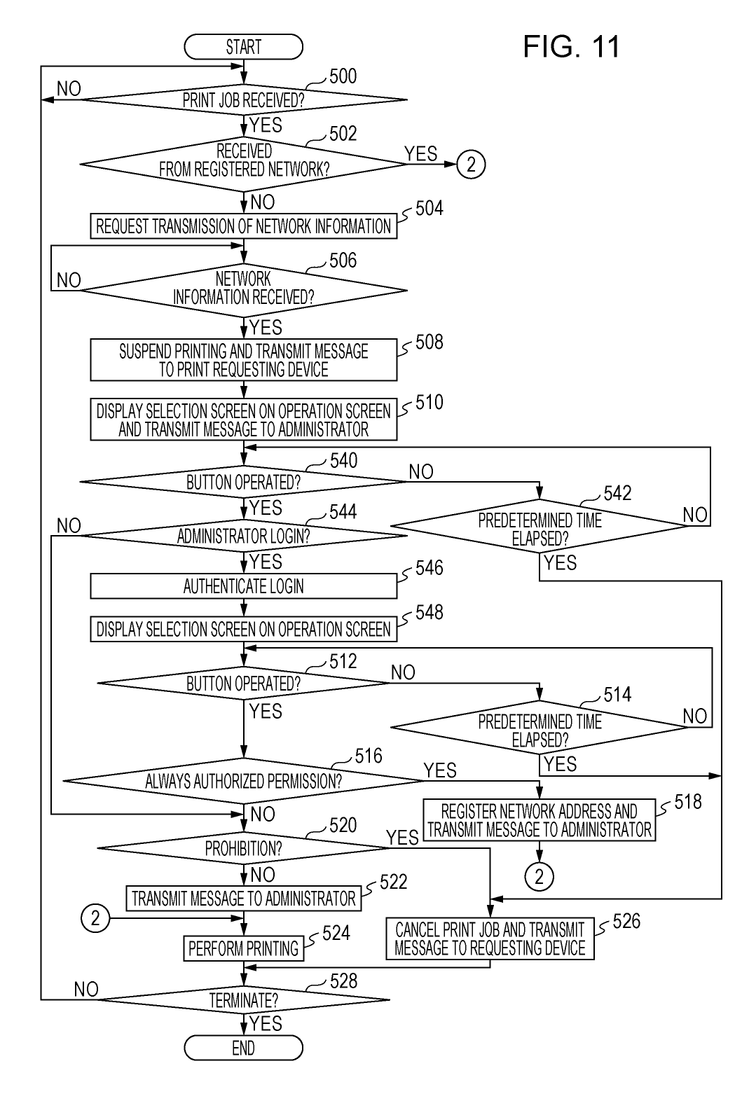

FIG. 11 illustrates a print processing program executed by the image forming apparatus 100 according to this embodiment. The flowchart illustrated in FIG. 11 is different from the flowchart illustrated in FIG. 6 only in that steps 540 to 548 are added. In FIG. 11 and FIG. 6, the processes of the steps assigned the same reference numerals are substantially identical.

In the first to fourth terminal devices 200 and 230 to 234, a print request program is executed in the way illustrated in FIG. 5, and a print request is sent to the image forming apparatus 100. In the image forming apparatus 100, similarly to the first embodiment, upon receipt of a print job, the CPU 102 determines whether the print job is a print request from a registered network. If the print job is a print request from a registered network, printing is performed.

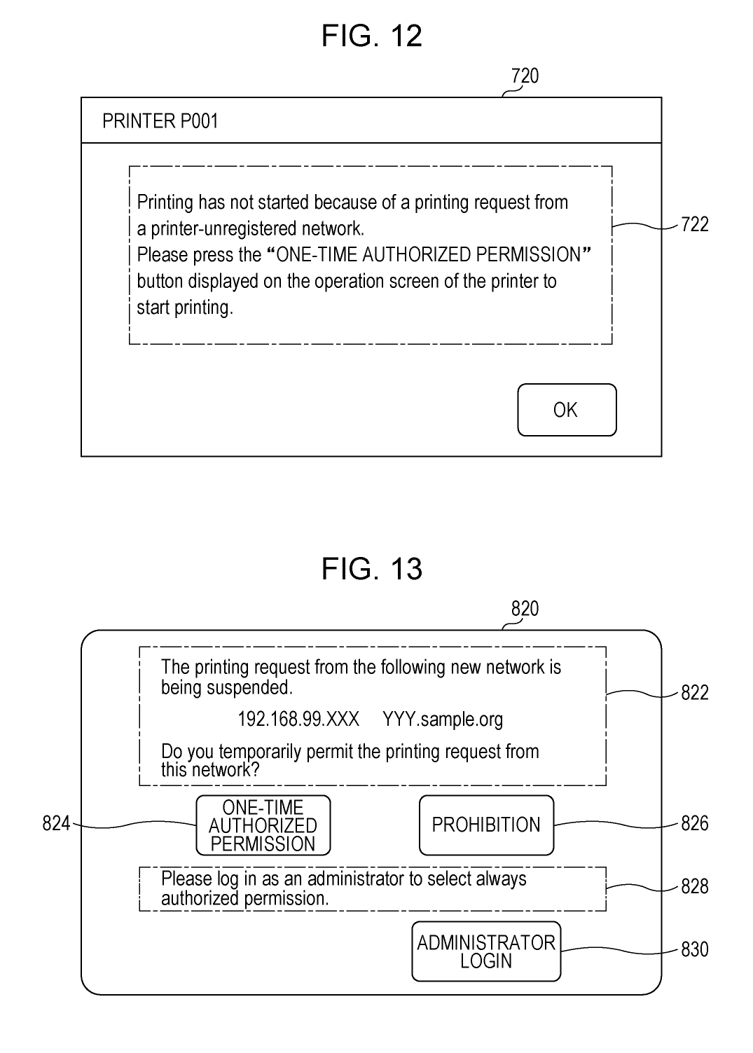

If the print job is not a print request from a registered network, in step 508, the CPU 102 suspends the execution of the received print job, and transmits a message indicating the suspension of printing to the device that has transmitted the print job because the print request is sent from an unregistered network. The message to be transmitted is different from that in the first embodiment, and a screen different from the screen 700 is displayed on a display unit of the terminal device that has transmitted the print job. For example, a screen 720 illustrated in FIG. 12 is displayed. The screen 720 has an area 722 in which a message indicating that it is necessary for a user to select the “One-Time Authorized Permission” button to perform printing is displayed.

In step 510, the CPU 102 transmits, to the administrator computer (i.e., the server 300), a message indicating the reception of a print request from an unregistered network, and displays a selection screen on the operation unit 116. Since the message for the terminal device that has transmitted the print job is different from that in the first embodiment, a selection screen to be displayed on the operation unit 116 is also different from that in the first embodiment. For example, a screen 820 illustrated in FIG. 13 is displayed. After displaying a screen, the CPU 102 obtains the current time from the timer, and stores the current time in the RAM 106 as the start time.

The screen 820 has an area 822 in which a message indicating the suspension of the execution of the print job is displayed, and two buttons 824 and 826 below the area 822 as buttons for selecting how the print job is to be processed. The screen 820 also has an area 828 in which a message indicating that it is necessary to log in as an administrator to select always authorized permission is displayed, and an “Administrator Login” button 830 below the area 828.

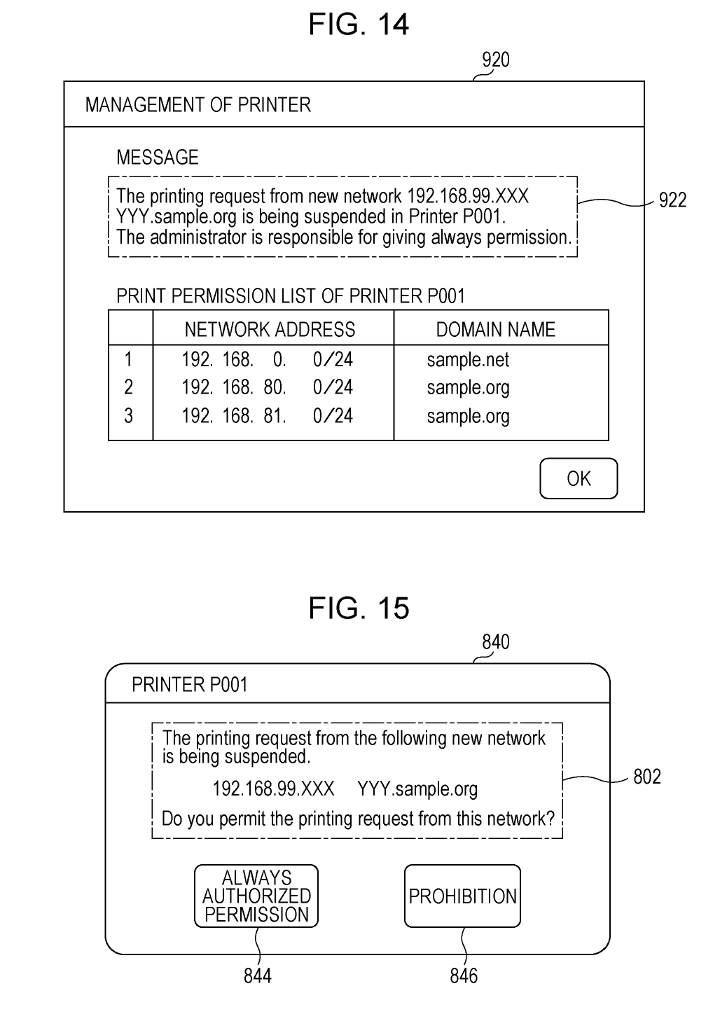

Based on the message transmitted to the server 300, for example, a screen 920 illustrated in FIG. 14 is displayed on the display unit 312. The screen 920 has an area 922 in which, in addition to a message indicating the reception of a print request from an unregistered network, a message indicating that it is necessary for an administrator to grant always authorized permission is displayed. Upon viewing the screen 920, the administrator can operate the screen 820 displayed on the operation unit 116 of the image forming apparatus 100 to grant always authorized permission. If it is not necessary to grant always authorized permission, the administrator may ignore the screen 920 and may not operate the screen 820 displayed on the image forming apparatus 100.

In step 540, the CPU 102 determines whether or not any of the buttons 824, 826, and 830 displayed on the screen 820 illustrated in FIG. 13 has been selected. If it is determined that any button has been selected, the CPU 102 makes the screen 820 disappear, and then the control proceeds to step 544. Otherwise, the control proceeds to step 542.

In step 542, the CPU 102 determines whether or not a predetermined time period has elapsed since the screen was displayed on the operation unit 116 in step 510. Specifically, the CPU 102 obtains the current time from the timer, reads the start time stored in the RAM 106 in step 510, and determines whether or not a predetermined time period has elapsed since the start time. If it is determined that the predetermined time period has elapsed, the CPU 102 makes the screen 820 disappear, and then the control proceeds to step 526. Otherwise, the control returns to step 540.

In step 544, the CPU 102 determines whether or not the button determined in step 540 to have been selected is the “Administrator Login” button 830. If it is determined that the button is the “Administrator Login” button 830, the control proceeds to step 546. Otherwise, the control proceeds to step 520.

If the “One-Time Authorized Permission” button 824 has been selected (NO in step 520), the processing of steps 522 and 524 is executed, and printing is performed. If the “Prohibition” button 826 has been selected (YES in step 520), the processing of step 526 is executed, and the print job is canceled without being printed.

On the other hand, if the “Administrator Login” button 830 has been selected, in step 546, the CPU 102 displays a login screen and performs known login authentication. The login authentication is performed by, for example, login with a user ID and a password entered.

If the login authentication is successful, in step 548, the CPU 102 displays a selection screen on the operation unit 116. For example, as in the first embodiment, the screen 800 illustrated in FIG. 8 is displayed. After displaying a screen, the CPU 102 obtains the current time from the timer, and stores the current time in the RAM 106 as the start time. The start time is used for determination in step 514 as to whether or not a predetermined time period has elapsed.

If the “Always Authorized Permission” button 804 has been selected on the screen 800 (FIG. 8) (YES in step 516), the network address is registered to the print permission list (step 518), and printing is performed (step 524). If the “Prohibition” button 808 has been selected (NO in step 516 and YES in step 520), the processing of step 526 is executed, and the print job is canceled without being printed. If the “One-Time Authorized Permission” button 806 has been selected (NO in step 516 and NO in step 520), the processing of steps 522 and 524 is executed, and printing is performed.

Accordingly, upon receipt of a print job from a terminal device belonging to a network not registered in the print permission list (NO in step 502), the image forming apparatus 100 can suspend the print job and perform processing in accordance with instructions.

When the screen 720 (FIG. 12) is displayed on a terminal device immediately after the user gives printing instructions by using the terminal device, the user goes to the image forming apparatus 100 and selects the “One-Time Authorized Permission” button 824 on the screen 820 (FIG. 13) so that printing can be performed. If the user has given printing instructions by mistake, the user can select the “Prohibition” button 826 to stop printing.

In the case of a print request from outside the organization that manages the image forming apparatus 100 (for example, in the case where instructions for printing a huge number of prints have been issued with malicious intent), a person who has made the print request will not be able to operate the screen 820 displayed on the image forming apparatus 100 and the print job is canceled with the lapse of a predetermined time period, thereby preventing the execution of unwanted printing. Since a message is also transmitted to the administrator computer (step 510), the execution of unwanted printing can also be prevented by the administrator's selection of the “Prohibition” button 826.

Pre-registration in the print permission list is not necessarily required. The selection of the “Always Authorized Permission” button 804 on the screen 800 (FIG. 8) displayed after the administrator's administrator login facilitates the registration of a network for which printing is permitted, if necessary. Since only the administrator can select the “Always Authorized Permission” button 804, inadvertent registration of a network to the print permission list can be prevented.

In the foregoing description, the screen 800 illustrated in FIG. 8 is displayed when the “Administrator Login” button 830 is selected and login authentication is successful. However, this is merely an example. For example, a screen 840 illustrated in FIG. 15 may be displayed. The screen 840 has an area 802 in which a message indicating the suspension of the execution of the print job is displayed, and buttons 844 and 846 below the area 802 for selecting how the print job is to be processed. Since only two buttons, namely, the “Always Authorized Permission” button 844 and the “Prohibition” button 846, are displayed on the screen 840 as selectable buttons, in FIG. 11, a negative result is not obtained in step 520 when a negative result is obtained in step 516.

In the foregoing description, in step 510, a message for the administrator is transmitted to the server 300. However, this is merely an example. For example, the message may be transmitted to a terminal device or mobile terminal device (such as a mobile phone or a smartphone) frequently used by the administrator.

In addition, in step 510, the message may not necessarily be transmitted to the administrator of the image forming apparatus 100. The message may be transmitted to a specific person who has privileges for the network 340.

Furthermore, the message may be presented in any way. The message may not necessarily be displayed as a screen, and may be presented via audio.

### Third Embodiment

In the first and second embodiments, a selection screen is displayed on an image forming apparatus to enable an operator of the image forming apparatus to select a process to be performed on a print job. In a third embodiment, in contrast, a process to be performed on a print job is performed by a specific person such as an administrator via a network.

A network printing system according to this embodiment, and an image forming apparatus, terminal devices, and a server that constitute the network printing system have a configuration similar to that of the first embodiment (FIGS. 1 to 4). A terminal device according to this embodiment executes a program similar to that (FIG. 5) in the first embodiment. A print processing program executed by the image forming apparatus is different from that in the first embodiment. In addition, unlike the first embodiment, the administrator computer executes a printing availability selection program. In the following, reference is made to the reference numerals in FIGS. 1 to 5.

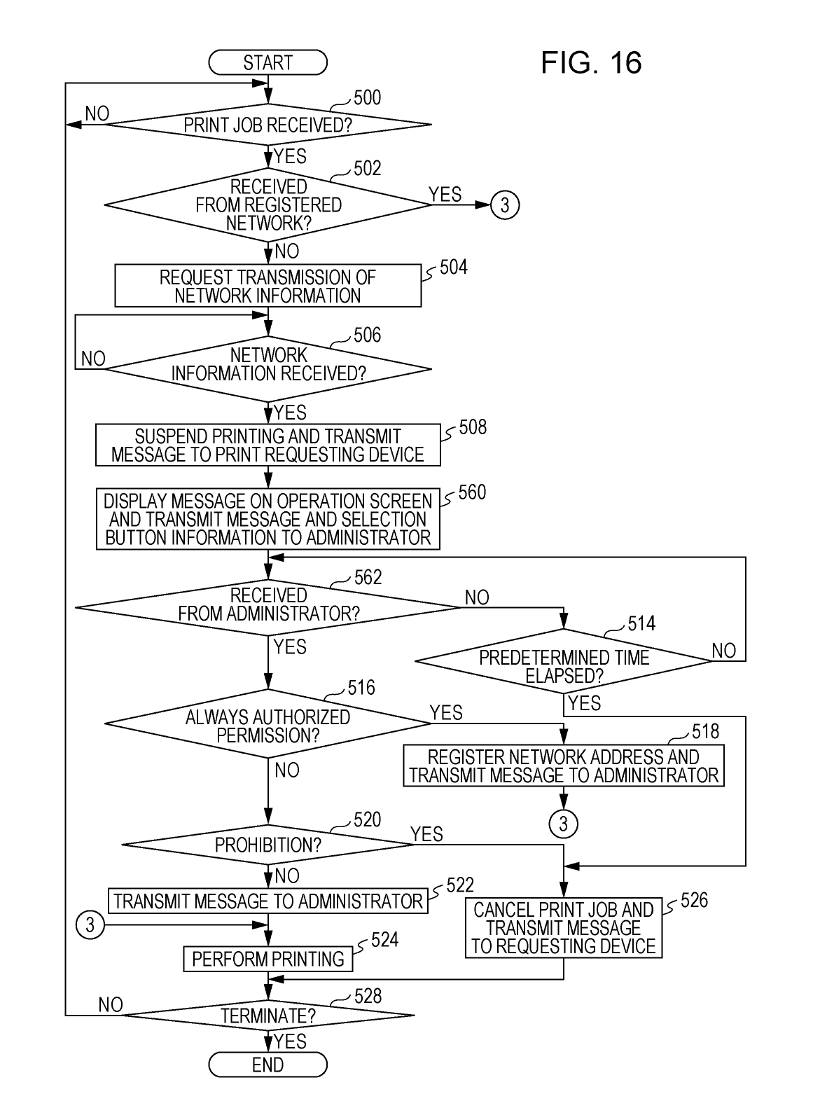

FIG. 16 illustrates a print processing program executed by the image forming apparatus 100 according to this embodiment. The flowchart illustrated in FIG. 16 is different from the flowchart illustrated in FIG. 6 only in that step 510 and step 512 are replaced with step 560 and step 562, respectively. In FIG. 16 and FIG. 6, the processes of the steps assigned the same reference numerals are substantially identical.

In the first to fourth terminal devices 200 and 230 to 234, a print request program is executed in the way illustrated in FIG. 5, and a print request is sent to the image forming apparatus 100. In the image forming apparatus 100, similarly to the first embodiment, upon receipt of a print job, the CPU 102 determines whether the print job is a print request from a registered network. If the print job is a print request from a registered network, printing is performed.

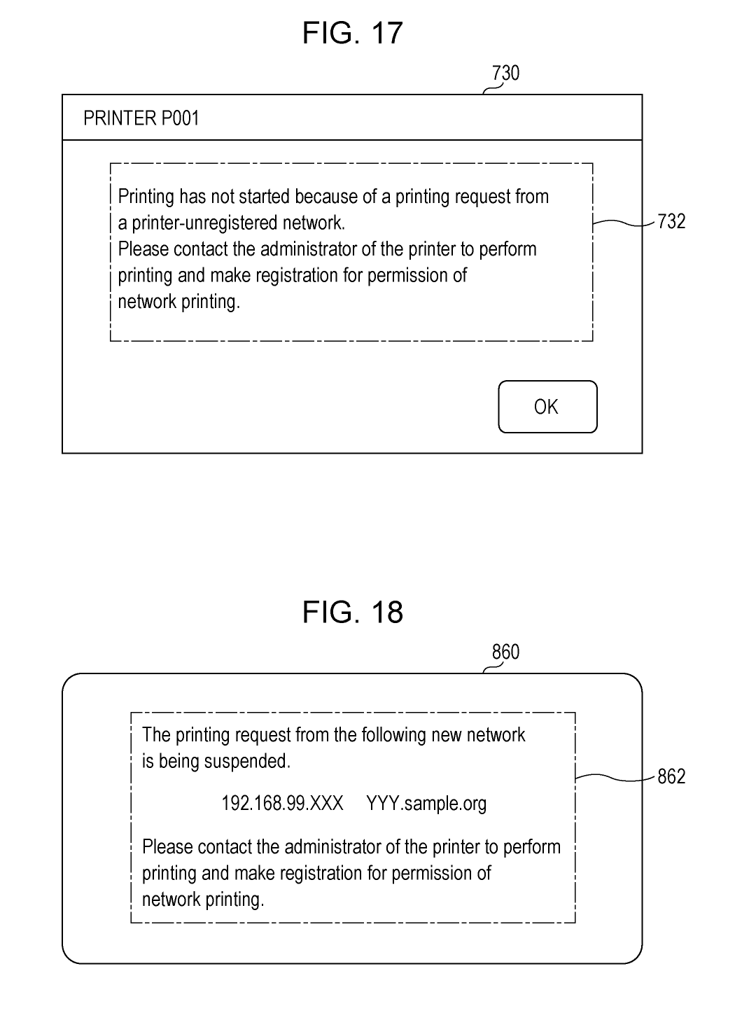

If the print job is not a print request from a registered network, in step 508, the CPU 102 suspends the execution of the received print job, and transmits a message indicating the suspension of printing to the device that has transmitted the print job because the print request is sent from an unregistered network. The message to be transmitted is different from that in the first embodiment, and a screen different from the screen 700 is displayed on a display unit of the terminal device that has transmitted the print job. For example, a screen 730 illustrated in FIG. 17 is displayed. The screen 730 has an area 732 in which a message indicating that printing has not started because the print request is sent from an unregistered network and a message indicating that it is necessary to contact the administrator to perform printing are displayed. When the screen 730 is displayed on a terminal device, the user can contact the administrator of the image forming apparatus 100 to ask them to take appropriate measures.

In step 560, the CPU 102 transmits, to the administrator computer (i.e., the server 300), a message indicating the reception of a print request from an unregistered network and selection button information, and displays a screen including a similar message on the operation unit 116. Since the message for the terminal device that has transmitted the print job is different from that in the first embodiment, the message to be displayed on the operation unit 116 is also different from that in the first embodiment. For example, a screen 860 illustrated in FIG. 18 is displayed. After displaying a screen, the CPU 102 obtains the current time from the timer, and stores the current time in the RAM 106 as the start time.

The screen 860 has an area 862 in which a message indicating the suspension of the execution of the print job and a message indicating that it is necessary to contact the administrator to perform printing are displayed. No buttons are displayed to give instructions to process the print job.

In step 562, the CPU 102 determines whether or not instructions have been received from the administrator computer (i.e., the server 300). The possible instructions to be received are instructions for one of “always authorized permission”, “prohibition”, and “one-time authorized permission”. Specifically, the CPU 102 receives data indicating one of “always authorized permission”, “prohibition”, and “one-time authorized permission”. If it is determined that instructions have been received, the control proceeds to step 516. Otherwise, the control proceeds to step 514.

In step 514, the CPU 102 determines whether or not a predetermined time period has elapsed since the screen was displayed on the operation unit 116 in step 560.

Specifically, the CPU 102 obtains the current time from the timer, reads the start time stored in the RAM 106 in step 560, and determines whether or not a predetermined time period has elapsed since the start time. If it is determined that the predetermined time period has elapsed, the CPU 102 makes the screen 860 disappear, and then the control proceeds to step 526. Otherwise, the control returns to step 562.

In step 516, the CPU 102 determines whether or not instructions for “always authorized permission” have been received in step 562. If it is determined that instructions for “always authorized permission” have been received, the processing of step 518 is executed, the network address determined in step 506 is registered to the print permission list (or stored in the HDD 108), and a message indicating the registration of the network address is transmitted to the administrator computer (i.e., the server 300). Thereafter, in step 524, printing is performed.

On the other hand, if instructions for “always authorized permission” have not been received, the processing of step 520 is executed, and the CPU 102 determines whether or not instructions for “prohibition” have been received in step 562. If instructions for “prohibition” have been received, the processing of step 526 is executed, and the print job received in step 500 is canceled (or deleted from the RAM 106 or the HDD 108). Then, a message indicating the cancellation of the transmitted print job is transmitted to the source of print job.

On the other hand, if instructions for “prohibition” have not been received, that is, if instructions for “one-time authorized permission” have been received, the processing of steps 522 and 524 is executed, and printing is performed.

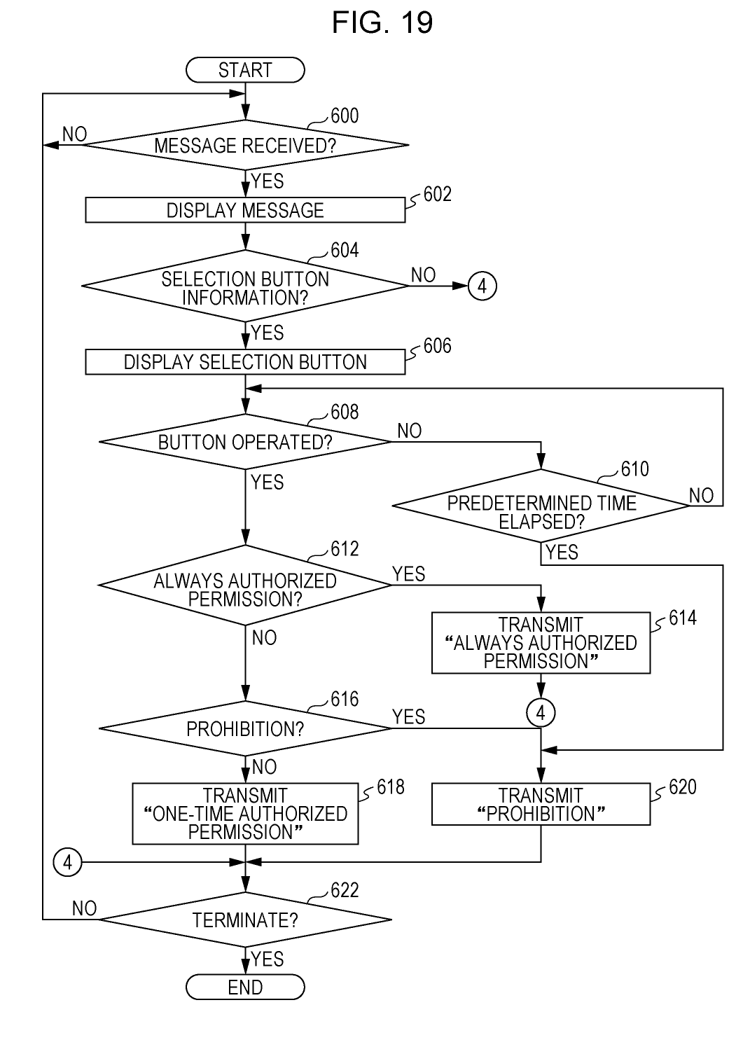

The printing availability selection program executed by the administrator computer (i.e., the server 300) is started when the power of the server 300 is turned on. Referring to FIG. 19, in step 600 of the printing availability selection program, the CPU 302 determines whether or not a message has been received from the image forming apparatus 100. If it is determined that a message has been received, the control proceeds to step 602. Otherwise, the processing of step 600 is repeatedly performed.

In step 602, the CPU 302 displays the message received in step 600 on the display unit 312.

In step 604, the CPU 302 determines whether or not selection button information has also been received in step 600 together with the message. If it is determined that selection button information has been received, the control proceeds to step 606. Otherwise, the control proceeds to step 622.

An affirmative result is obtained in step 604 in a case where the message and selection button information transmitted from the image forming apparatus 100 in step 560 in FIG. 16 have been received. A negative result is obtained in step 604 in a case where the message transmitted from the image forming apparatus 100 in step 518 or step 522 in FIG. 16 has been received.

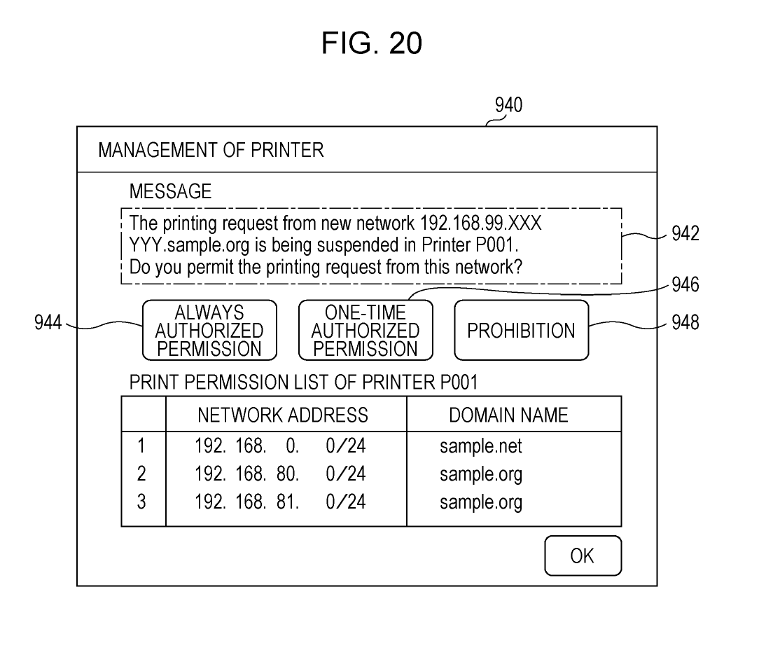

In step 606, the CPU 302 displays selection buttons on the display unit 312 in accordance with the selection button information received in step 600. For example, a screen 940 illustrated in FIG. 20 is displayed. The screen 940 has an area 942 in which a message indicating the suspension of the execution of the print job is displayed, and buttons 944, 946, and 948 below the area 942 for selecting how the print job is to be processed. Furthermore, information on networks for which printing from the image forming apparatus (i.e., Printer P001) is currently permitted is displayed below the selection buttons. After displaying the screen 940, the CPU 302 obtains the current time from the timer (not illustrated in FIG. 4), and stores the current time in the RAM 306 as the start time.

In step 608, the CPU 302 determines whether or not any of the buttons 944, 946, and 948 displayed on the screen 940 illustrated in FIG. 20 has been operated (or selected). If it is determined that any button has been operated, the CPU 302 makes the screen 940 disappear, and then the control proceeds to step 612. Otherwise, the control proceeds to step 610.

In step 610, the CPU 302 determines whether or not a predetermined time period has elapsed since the selection buttons were displayed on the display unit 312 in step 606. Specifically, the CPU 302 obtains the current time from the timer, reads the start time stored in the RAM 306 in step 606, and determines whether or not a predetermined time period has elapsed since the start time. If it is determined that the predetermined time period has elapsed, the CPU 302 makes the screen 940 disappear, and then the control proceeds to step 620. Otherwise, the control returns to step 608.

In step 612, the CPU 302 determines whether or not the button determined in step 608 to have been selected is the “Always Authorized Permission” button 944. If it is determined that the button is the “Always Authorized Permission” button 944, the control proceeds to step 614. Otherwise, the control proceeds to step 616.

In step 614, the CPU 302 transmits data indicating “always authorized permission” to the image forming apparatus 100. Then, the control proceeds to step 622.

If NO is determined in step 612, in step 616, the CPU 302 determines whether or not the button determined in step 608 to have been selected is the “Prohibition” button 948. If it is determined that the button is the “Prohibition” button 948, the control proceeds to step 620. Otherwise, the control proceeds to step 618.

In step 618, the CPU 302 transmits data indicating “one-time authorized permission” to the image forming apparatus 100.

In step 620, the CPU 302 transmits data indicating “prohibition” to the image forming apparatus 100.

In step 622, the CPU 302 determines whether or not instructions for terminating the program have been received. If it is determined that instructions for terminating the program have been received, the program ends. Otherwise, the control returns to step 600. The termination instructions are made by, for example, turning off the power of the server 300.

Accordingly, upon receipt of a print job from a terminal device belonging to a network not registered in the print permission list (NO in step 502), the image forming apparatus 100 can suspend the print job, ask the administrator how the print job is to be processed (or display the screen 940 on the server 300), and perform processing in accordance with instructions from the administrator.

When the screen 940 (FIG. 20) is displayed on the display unit 312 of the server 300, the administrator can select the “Always Authorized Permission” button 944 or the “One-Time Authorized Permission” button 946, without going to the image forming apparatus 100, to perform printing. The administrator can select the “Prohibition” button 948 to stop printing, when informed by the user that printing instructions have been given by mistake. In addition, in the case of a print request from outside the organization that manages the image forming apparatus 100 (for example, in the case where instructions for printing a huge number of prints have been issued with malicious intent), the administrator can select the “Prohibition” button 948 to prevent unwanted printing from being performed.

Furthermore, pre-registration in the print permission list is not necessarily required. The selection of the “Always Authorized Permission” button 944 on the displayed screen 940 facilitates the registration of a network for which printing is permitted, if necessary. Moreover, only the administrator can provide instructions as to whether or not to execute a print job. Thus, inadvertent registration of a network to the print permission list can be prevented.

When the image forming apparatus 100 transmits a message and selection button information to the server 300 in step 560, it may be sufficient that information for allowing the server 300 to display a screen, such as the screen 940 (FIG. 20), on the display unit 312 be transmitted, and the transmission of the message and the selection button information is optional. For example, for the message, text data of the message to be displayed in the area 942 may be transmitted or, if the HDD 308 of the server 300 has stored therein in advance boilerplate message information, only text data of network information (“192.168.99.XXX YYY.sample.org” in FIG. 20) may be transmitted. For the selection button information, image data of the buttons 944 to 948 may be transmitted, or only text information (text data) shown in the buttons 944 to 948 may be transmitted. If the HDD 308 of the server 300 has stored therein in advance image data of selection buttons, only code for instructions to display the selection buttons may be transmitted.

In the first to third embodiments described above, by way of example, a terminal device transmits a subnet mask as network information. However, this is merely an example. For example, a terminal device may transmit, as network information, a network address, a domain name, or the like. A terminal device can determine the network address of the segment to which the terminal device belongs, on the basis of its IP address and subnet mask.

The flowcharts illustrated in FIG. 5, FIG. 6, FIG. 11, FIG. 16, and FIG. 19 according to the first to third embodiments described above may be modified, as desired, and executed. For example, in the foregoing description, upon receipt of a request from the image forming apparatus 100, a terminal device that has transmitted a print job transmits network information. However, this is merely an example. Each terminal device may spontaneously transmit network information when transmitting a print job to the image forming apparatus 100. In this case, the image forming apparatus 100 does not need to request a terminal device to transmit network information. In the case of transmitting network information when transmitting a print job, a terminal device may transmit a print job which includes network information or may transmit network information as separate data from a print job. Even in a case where the image forming apparatus 100 receives print jobs almost simultaneously from a plurality of terminal devices, the image forming apparatus 100 can determine network information associated with the respective print jobs from the source IP addresses included in the received packets.

In a case where a terminal device spontaneously transmits network information when transmitting a print job to the image forming apparatus 100, the image forming apparatus 100 can identify the network address of the segment to which the terminal device belongs, by using the received network information. Accordingly, in step 502, it may be determined whether or not the identified network address has been registered in the print permission list. For example, if the image forming apparatus 100 receives a subnet mask as network information, the image forming apparatus 100 identifies the network portion of the IP address of the terminal device that has transmitted the print job, and determines whether or not the identified network portion matches any network address registered in the print permission list.

Further, the image forming apparatus 100 may request the terminal device that has transmitted the print job to transmit network information, by using, for example, the well-known traceroute command. In this case, the terminal device does not need to transmit network information. The traceroute command allows information (IP addresses) on routers along a path to the destination host (i.e., the terminal device) to be obtained, from which the address of the network to which the destination host belongs can be determined. Accordingly, it may be sufficient to execute the traceroute command by designating the IP address of the terminal device that has transmitted the print job as the destination host.

In the following description, furthermore, the control waits for network information to be received in step 506 in FIG. 6, FIG. 11, and FIG. 16. Alternatively, the control may proceed to step 526 if no network information is received within a predetermined time period. This can prevent the adverse effect caused by waiting for network information for a long time. If a terminal device transmits an unauthorized print job, a request for network information might not reach the terminal device.

In the foregoing description, furthermore, in the processing steps of determining which of the three options (buttons) has been selected in the flowcharts illustrated in FIG. 6, FIG. 16, and FIG. 19, whether or not “always authorized permission” has been selected is determined first, and then whether or not “prohibition” has been selected is determined. However, this is merely an example. The processing steps for determining which of the three options has been selected may be performed in any order.

In the first to third embodiments described above, by way of example, print permission is set for network addresses. However, this is merely an example. Print permission may be set for respective terminal devices. In this case, the IP addresses of terminal devices are registered instead of or in addition to network addresses in the print permission list. An image forming apparatus determines whether or not the IP address of a terminal device that has transmitted a received print job is included in the print permission list. That is, the image forming apparatus determines whether or not the IP address of the terminal device matches any of the IP addresses registered in the print permission list and the IP addresses identified by the network addresses registered in the print permission list. If no match is found, as in the first to third embodiments, an “Always Authorized Permission” button, a “Temporarily Authorized Permission” or “One-Time Authorized Permission” button, and a “Prohibition” button are displayed on the image forming apparatus or the administrator's terminal device (such as a server). The image forming apparatus may be sufficient to perform processing in accordance with the operation of the user or the administrator.

In the foregoing description, if “always authorized permission” is selected, a network address is registered to the print permission list. However, this is merely an example. The address (IP address) of a terminal device may be registered instead. That is, permission for printing may be set for individual terminal devices (hosts). The “always authorized permission” option may be further divided into two options. For example, an “Always Authorized Permission for Network” button and an “Always Authorized Permission for Host” button may be displayed instead of the “Always Authorized Permission” button. In this case, in response to the selection of the “Always Authorized Permission for Network” button, as described above, the network address of the segment to which a terminal device belongs is registered to the print permission list, whereas, in response to the selection of the “Always Authorized Permission for Host” button, the IP address of a terminal device that has transmitted a print job is registered to the print permission list.

In the first to third embodiments described above, by way of example, the communication protocol is TCP/IP. However, this is merely an example. In the foregoing description, furthermore, class-C networks with a network portion of 24 bits are used. However, this is merely an example. The number of bits of the network portion is arbitrary. In the foregoing description, furthermore, private IP addresses are used as the IP addresses. However, this is merely an example. Global IP addresses may be used.

### Fourth Embodiment

A network printing system according to a fourth embodiment is common to that illustrated in FIG. 1, and is not redundantly described.

Further, similar elements are given the same numerals.

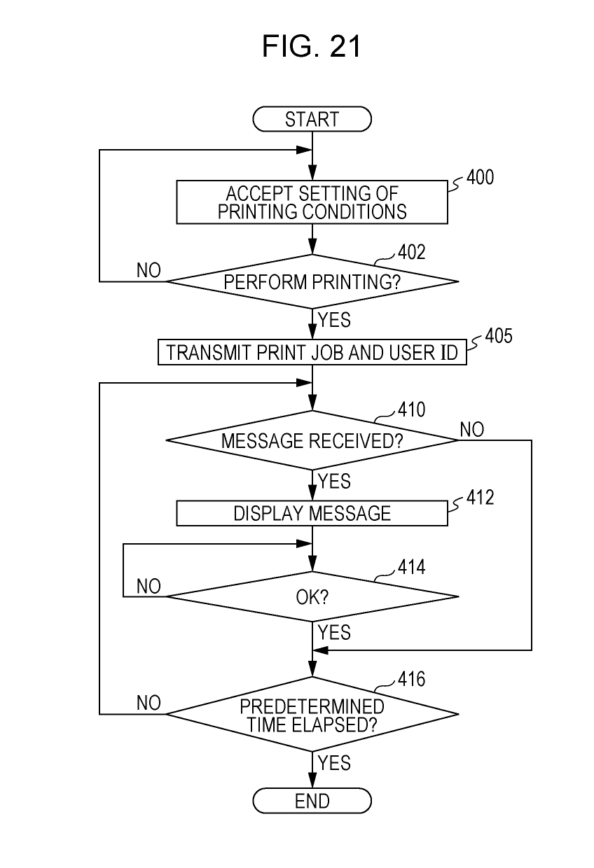

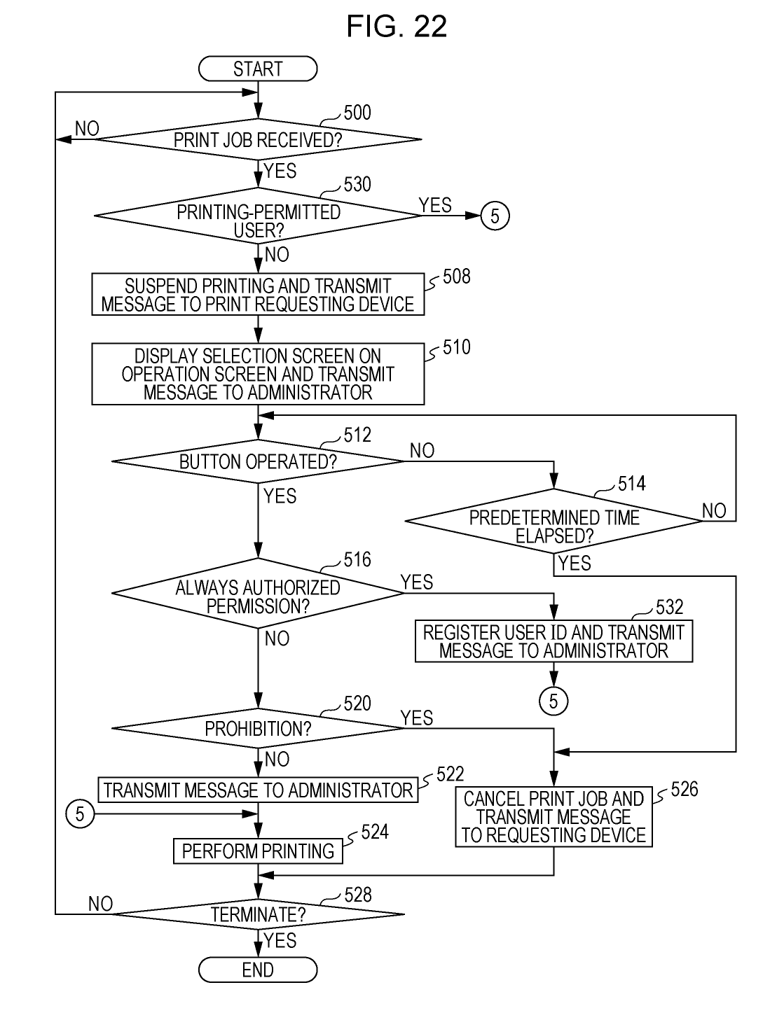

In the following, a print service provided by the network printing system illustrated in FIG. 1 will be described with reference to FIG. 21 and FIG. 22. The transmission of a print job from the first terminal device 200 to the image forming apparatus 100 involves the use of the network communication function of the first terminal device 200. Thus, known login authentication for login to the network 340 is performed.

The image forming apparatus 100 has a print permission list in which permission information for identifying a target for which printing is permitted is registered in advance. Here, the permission information is information identifying a user (hereinafter also referred to as a “user ID”). The print permission list is stored in the HDD 108. Upon receipt of a print request (print job) via the network 340, the image forming apparatus 100 performs printing if the print request has been made by a user identified by a registered user ID. Otherwise, the image forming apparatus 100 suspends printing.

Referring to FIG. 21, the processing of steps 400 and 402 in a print request program executed by the first terminal device 200 is similar to that in FIG. 5, and is not described herein.

In step 405, the CPU 202 generates a print job in accordance with the printing conditions set in step 400, and transmits a data file including the generated print job and information (user ID) identifying a user who has given instructions to generate the job to the image forming apparatus 100 selected in step 400 via the NIC 210. The user who has given instructions to generate the job is a user who is logging in to the first terminal device 200. Such a user is identified by a login ID, and thus a login ID is used as a user ID. The data file (the print job and the user ID) is transmitted in the form of packets, and each packet has a communication header in which the IP address of the image forming apparatus 100 is set as a destination address and the IP address of the first terminal device 200 is set as a source address. The communication header includes well-known additional information based on TCP/IP. For example, the communication header includes the Media Access Control (MAC) addresses of the image forming apparatus 100 and the first terminal device 200, and information (such as identification, flags, and fragment offset) indicating the order of transmission of the packets to enable the destination device (i.e., the image forming apparatus 100) to reconfigure the original data (print job) from the plurality of transmitted packets.

When the transmission of the data file (the print job and the user ID) is completed, the CPU 202 obtains information indicating the current time (hereinafter also referred to as the “current time”) from the timer (not illustrated in FIG. 3), and stores the current time in the RAM 206 as the start time.

The processing of steps 410 to 416 is substantially the same as that in FIG. 5, and is not described herein.

That is, in the first embodiment, determination is based on a network, whereas, in the fourth embodiment, determination is based on a user ID.

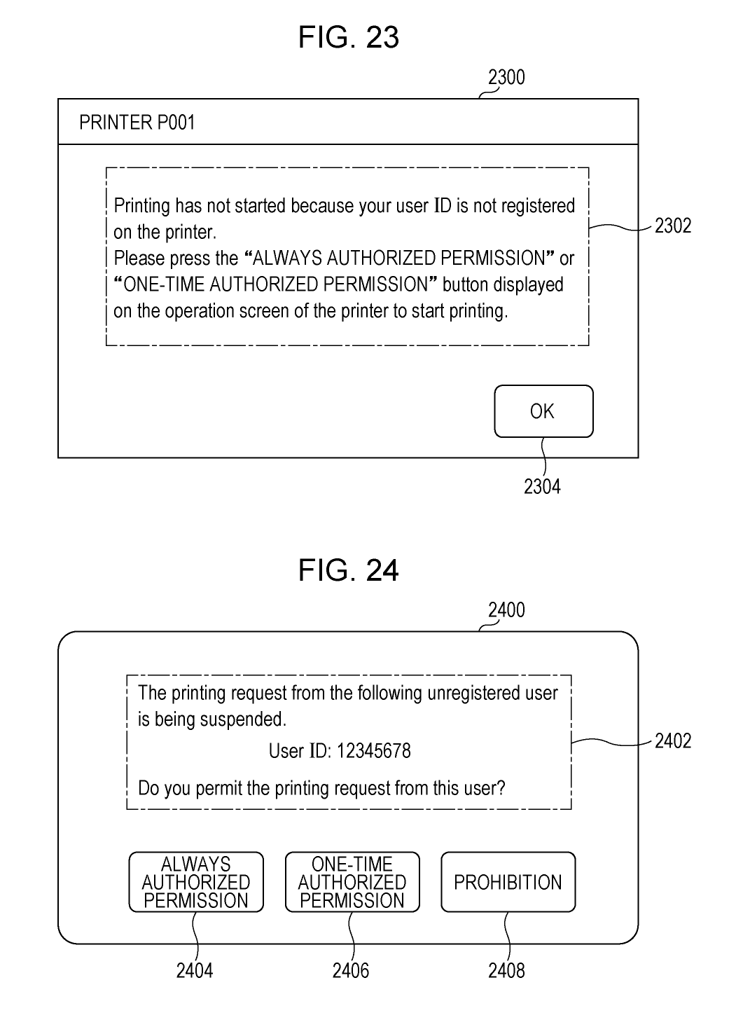

Accordingly, after transmitting a data file including a print job and a user ID, the first terminal device 200 waits for a message from the image forming apparatus 100, which is the destination, for a predetermined time period. Each time a message is received within the predetermined time period, the content of the message is displayed on the display unit 212. That is, as described below, a screen illustrated in FIG. 23 is displayed in step 508 in FIG. 22, and a screen illustrated in FIG. 26 is displayed in step 526 in FIG. 22.

The second terminal device 230 also executes a similar print request program.

A print processing program executed by the image forming apparatus 100 will be described with reference to FIG. 22. In step 500, the CPU 102 determines whether or not a print job has been received. If it is determined that a print job has been received, the control proceeds to step 530. Otherwise, the processing of step 500 is repeatedly performed. The CPU 102 stores the received data (a print job and a user ID) in the RAM 106 or the HDD 108. The CPU 102 stores the source IP address included in the received packets in the RAM 106 as information identifying a device that has transmitted the print job.

In step 530, the CPU 102 determines whether or not the print job received in step 500 is a print job generated in accordance with instructions given by a user for which printing is permitted. Specifically, the CPU 102 determines whether or not the user ID stored in the RAM 106 in step 500 matches any of the user IDs registered in the print permission list as permission information. If a user ID is matched, it is determined that the print job is a print job generated in accordance with instructions given by an authorized user. If a user ID is matched, the control proceeds to step 524. Otherwise, that is, if the received user ID has not been registered in the print permission list, the control proceeds to step 508.

In step 508, the CPU 102 suspends the execution of the print job received in step 500, and transmits a message indicating the suspension of printing to the device that has transmitted the print job because the print request is sent from an unauthorized user. The CPU 102 transmits data (such as image data or text data) indicating the message using the source IP address stored in the RAM 106 in step 500 as the destination IP address. The transmitted message is received by the terminal device that has transmitted the print job (step 410 in FIG. 21) and is displayed (step 412). Accordingly, for example, a screen 2300 illustrated in FIG. 23 is displayed on the terminal device that has transmitted the print job.

In step 510, the CPU 102 transmits, to the administrator computer (i.e., the server 300), a message indicating the reception of a print request from an unregistered user, and displays a selection screen on the operation unit 116. Specifically, a screen 2400 illustrated in FIG. 24 is displayed. The screen 2400 has an area 2402 in which a message indicating the suspension of the execution of the print job from an unregistered user is displayed, and buttons 2404, 2406, and 2408 below the area 2402 for selecting how the print job is to be processed. After displaying the screen 2400, the CPU 102 obtains the current time from the timer (not illustrated in FIG. 2), and stores the current time in the RAM 106 as the start time. The transmitted message is displayed on the administrator computer.

In step 512, the CPU 102 determines whether or not any of the buttons 2404, 2406, and 2408 displayed on the screen 2400 illustrated in FIG. 24 has been operated (or selected). If it is determined that any button has been operated, the CPU 102 makes the screen 2400 disappear, and then the control proceeds to step 516. Otherwise, the control proceeds to step 514.

In step 514, the CPU 102 determines whether or not a predetermined time period has elapsed since the screen was displayed on the operation unit 116 in step 510. Specifically, the CPU 102 obtains the current time from the timer, reads the start time stored in the RAM 106 in step 510, and determines whether or not a predetermined time period has elapsed since the start time. If it is determined that the predetermined time period has elapsed, the CPU 102 makes the screen 2400 disappear, and then the control proceeds to step 526. Otherwise, the control returns to step 512.

In step 516, the CPU 102 determines whether or not the button determined in step 512 to have been operated is the “Always Authorized Permission” button 2404. If it is determined that the button is the “Always Authorized Permission” button 2404, the control proceeds to step 532. Otherwise, the control proceeds to step 520.

In step 532, the CPU 102 registers the user ID received in step 500 to the print permission list (stores the user ID in the HDD 108), and transmits a message indicating the registration of the user ID to the administrator computer (i.e., the server 300). Then, the control proceeds to step 524.

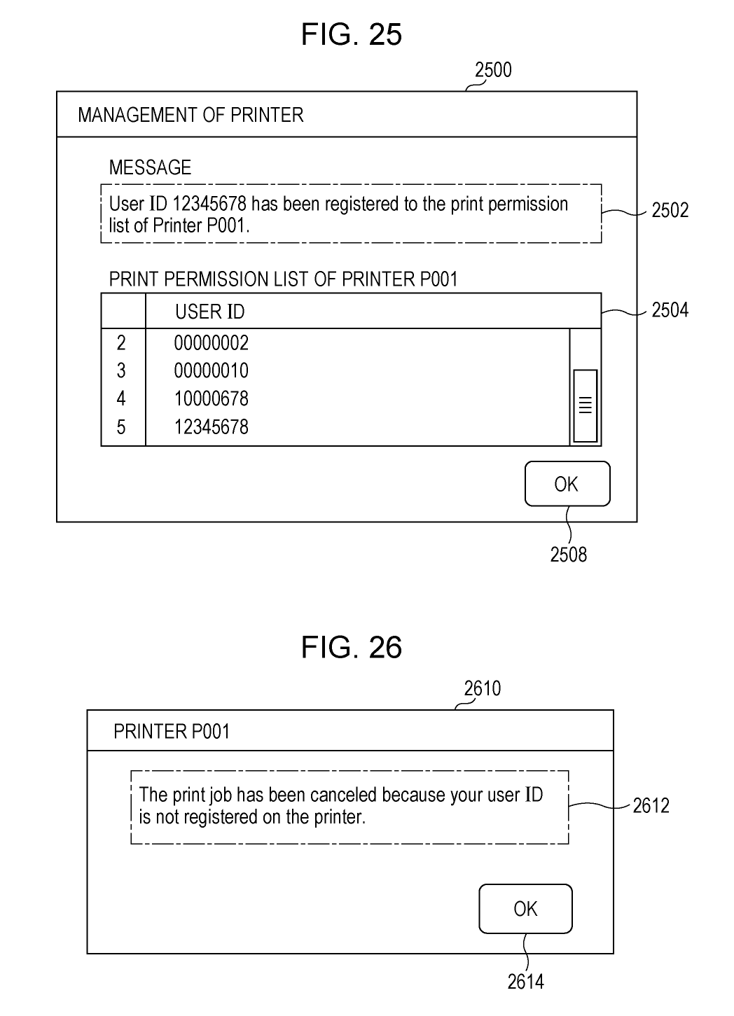

For example, a screen 2500 illustrated in FIG. 25 is displayed on the server 300. The screen 2500 has an area 2502 in which a message including information (P001) identifying the printer (i.e., the image forming apparatus 100) and indicating that a new user ID (12345678) has been registered to the printer is displayed. A table 2504 shows user IDs for which the use of the printer is permitted, in association with the information (P001) identifying the printer, which is included in the message. The newly registered user ID (12345678) is shown in the bottom row of the table 2504. The server 300 holds information for providing a network connection service, and can thus determine, based on the source IP address included in the packets of the message transmitted in step 532, information identifying the corresponding one of the printers (such as the name of the printer). If an OK button 2508 is selected, the screen 2500 disappears.

If NO is determined in step 516, in step 520, the CPU 102 determines whether or not the button determined in step 512 to have been operated is the “Prohibition” button 2408. If it is determined that the button is the “Prohibition” button 2408, the control proceeds to step 526. Otherwise, the control proceeds to step 522.

In step 522, the CPU 102 transmits, to the administrator computer (i.e., the server 300), a message indicating that printing has been permitted just this once in response to a print request from an unregistered user ID.

In step 524, the CPU 102 executes the print job received in step 500.

In step 526, the CPU 102 cancels or discards the print job received in step 500 (or deletes the print job from the RAM 106 or the HDD 108), and transmits a message indicating the cancellation of the transmitted print job to the source of the print job. The source IP address stored in the RAM 106 in step 500 is used as the destination IP address. Accordingly, a screen 2610 illustrated in FIG. 26 is displayed on the terminal device that has transmitted the print job through the processing of steps 410 and 412 in FIG. 21. The screen 2610 has an area 2612 in which the received message is displayed. If an OK button 2614 is selected, the screen 2610 disappears.

In step 528, the CPU 102 determines whether or not instructions for terminating the program have been received. If it is determined that instructions for terminating the program have been received, the program ends. Otherwise, the control returns to step 500. The termination instructions are made by, for example, turning off the power of the image forming apparatus 100.

Accordingly, upon receipt of a print job together with a user ID not registered in the print permission list (NO in step 530), the image forming apparatus 100 can suspend the print job and perform processing in accordance with instructions. If always authorized permission is selected (YES in step 516), the image forming apparatus 100 registers the corresponding user ID to the print permission list (step 532), and performs printing in accordance with the print job (step 524). If printing is prohibited (YES in step 520), the image forming apparatus 100 cancels the received print job (step 526). If printing is permitted just this once as an exception (NO in step 520), the image forming apparatus 100 performs printing in accordance with the print job (step 524) although the corresponding user ID is not registered to the print permission list.

When the screen 2300 (FIG. 23) is displayed on a terminal device immediately after the user gives printing instructions by using the terminal device, the user goes to the image forming apparatus 100 and operates a button on the screen 2400 (FIG. 24) so that printing can be performed. If the user has given printing instructions by mistake, the user can select the “Prohibition” button 2408 to stop printing.

In the case of a print request from outside the organization that manages the image forming apparatus 100 (for example, in the case where instructions for printing a huge number of prints have been issued with malicious intent), a person who has made the print request will not be able to operate the screen 2400 displayed on the image forming apparatus 100 and the print job is canceled with the lapse of a predetermined time period, thereby preventing the execution of unwanted printing. Since a message is also transmitted to the administrator computer (step 510), the execution of unwanted printing can also be prevented by the administrator's selection of the “Prohibition” button 2408.

Pre-registration in the print permission list is not necessarily required. The selection of the “Always Authorized Permission” button 2404 on the displayed screen 2400 facilitates the registration of a user ID for which printing is permitted, if necessary.

### Fifth Embodiment

In the fourth embodiment, a user who has transmitted a print request can select the “Always Authorized Permission” button. In a fifth embodiment, in contrast, only a specific person such as an administrator can select the “Always Authorized Permission” button.

A network printing system according to this embodiment, and an image forming apparatus, terminal devices, and a server that constitute the network printing system have a configuration similar to that of the first embodiment (FIGS. 1 to 4). A terminal device according to this embodiment executes a program similar to that (FIG. 21) in the fourth embodiment. A print processing program executed by the image forming apparatus is different from that in the fourth embodiment.

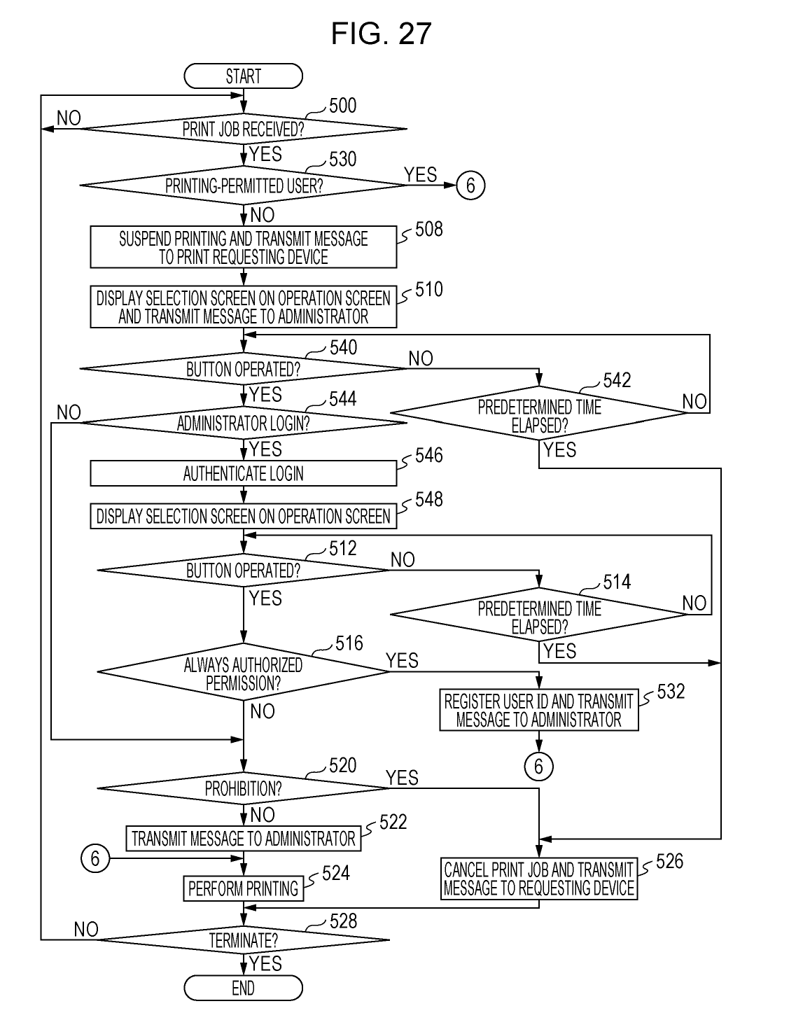

FIG. 27 illustrates a print processing program executed by the image forming apparatus 100 according to this embodiment. The flowchart illustrated in FIG. 27 is different from the flowchart illustrated in FIG. 22 only in that steps 540 to 548 are added. In FIG. 27 and FIG. 22, the processes of the steps assigned the same reference numerals are substantially identical.

In the first terminal device 200 and the second terminal device 230, a print request program is executed in the way illustrated in FIG. 21, and a print request is sent to the image forming apparatus 100. In the image forming apparatus 100, similarly to the first embodiment, upon receipt of a print job, the CPU 102 determines whether the print request is a print request from a user for which printing is permitted. If the print request is a print request from a user for which printing is permitted, printing is performed. The user for which printing is permitted is a user whose user ID has been registered in the print permission list.

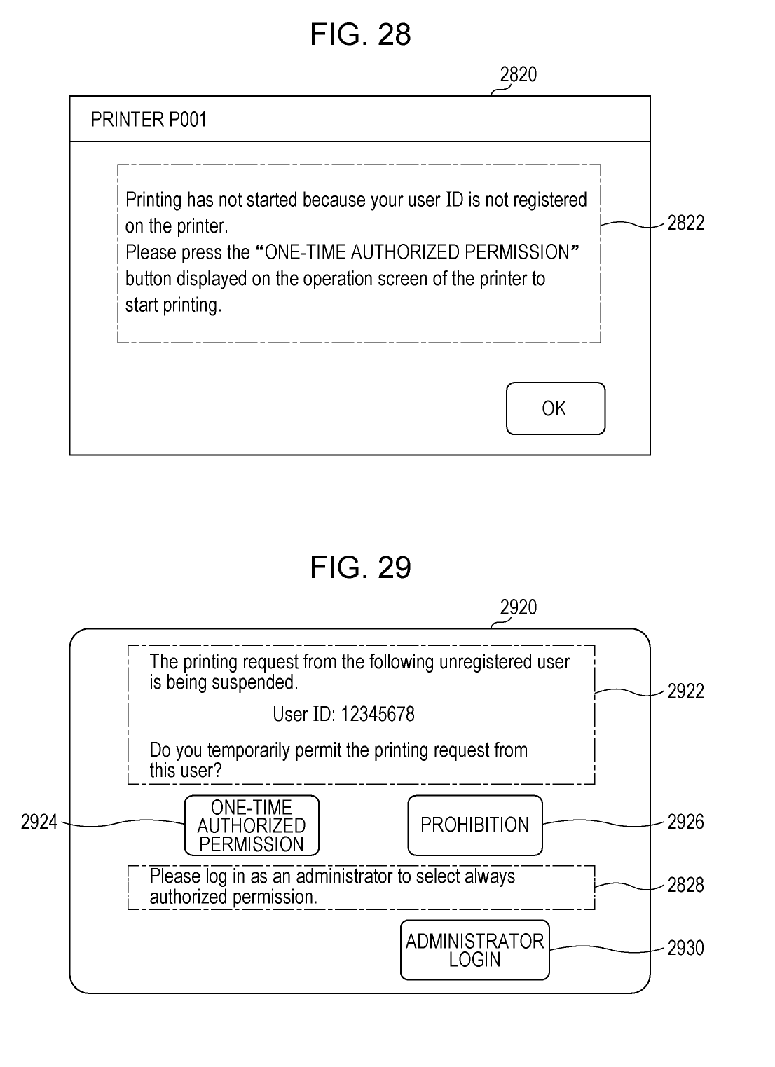

If the print request is not a print request from a registered user, in step 508, the CPU 102 suspends the execution of the received print job, and transmits a message indicating the suspension of printing to the device that has transmitted the print job because the print request is sent from an unregistered user. The message to be transmitted is different from that in the fourth embodiment, and a screen different from the screen 2300 is displayed on a display unit of the terminal device that has transmitted the print job. For example, a screen 2820 illustrated in FIG. 28 is displayed. The screen 2820 has an area 2822 in which a message indicating that it is necessary for a user to select the “One-Time Authorized Permission” button to perform printing is displayed.

In step 510, the CPU 102 transmits, to the administrator computer (i.e., the server 300), a message indicating the reception of a print request from an unregistered user, and displays a selection screen on the operation unit 116. Since the message for the terminal device that has transmitted the print job is different from that in the fourth embodiment, a selection screen to be displayed on the operation unit 116 is also different from that in the fourth embodiment. For example, a screen 2920 illustrated in FIG. 29 is displayed. After displaying a screen, the CPU 102 obtains the current time from the timer, and stores the current time in the RAM 106 as the start time.

The screen 2920 has an area 2922 in which a message indicating the suspension of the execution of the print job from an unregistered user is displayed, and two buttons 2924 and 2926 below the area 2922 for selecting how the print job is to be processed. The screen 2920 also has an area 2928 in which a message indicating that it is necessary to log in as an administrator to select always authorized permission is displayed, and an “Administrator Login” button 2930 below the area 2928.

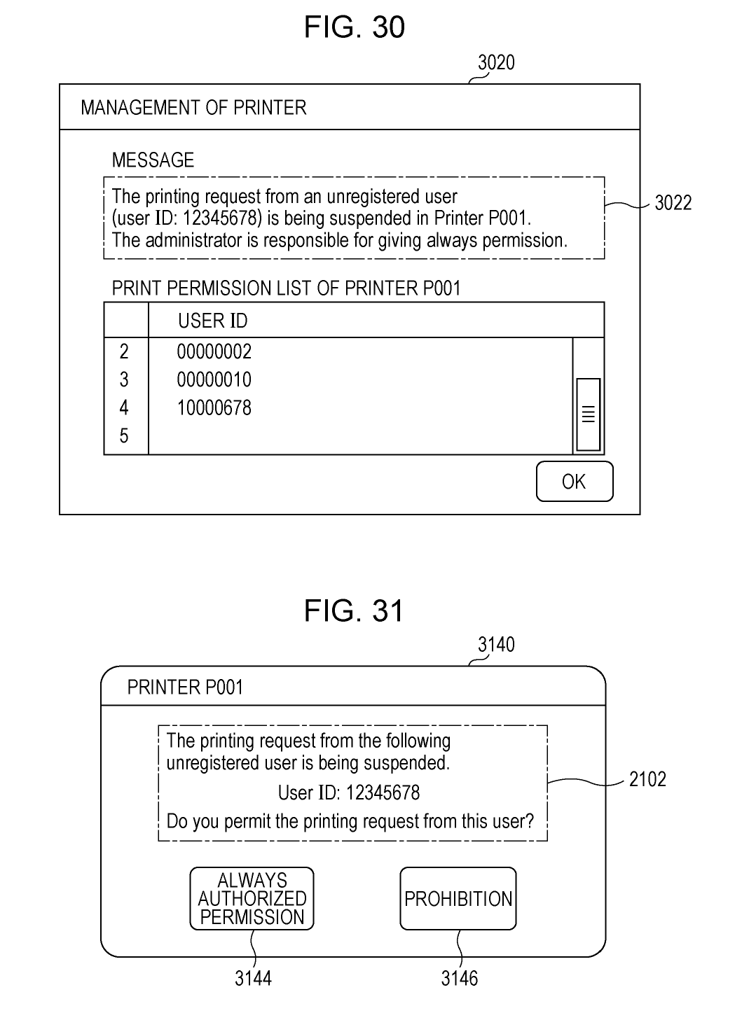

Based on the message transmitted to the server 300, for example, a screen 3020 illustrated in FIG. 30 is displayed on the display unit 312. The screen 3020 has an area 3022 in which, in addition to a message indicating the suspension of the print request from an unregistered user, a message indicating that it is necessary for an administrator to grant always authorized permission is displayed. Upon viewing the screen 3020, the administrator can operate the screen 3020 displayed on the operation unit 116 of the image forming apparatus 100 to grant always authorized permission. If it is not necessary to grant always authorized permission, the administrator may ignore the screen 3020 and may not operate the screen 2920 displayed on the image forming apparatus 100.

In step 540, the CPU 102 determines whether or not any of the buttons 2924, 2926, and 2930 displayed on the screen 2920 illustrated in FIG. 29 has been selected. If it is determined that any button has been selected, the CPU 102 makes the screen 2920 disappear, and then the control proceeds to step 544. Otherwise, the control proceeds to step 542.

In step 542, the CPU 102 determines whether or not a predetermined time period has elapsed since the screen was displayed on the operation unit 116 in step 510. Specifically, the CPU 102 obtains the current time from the timer, reads the start time stored in the RAM 106 in step 510, and determines whether or not a predetermined time period has elapsed since the start time. If it is determined that the predetermined time period has elapsed, the CPU 102 makes the screen 2920 disappear, and then the control proceeds to step 526. Otherwise, the control returns to step 540.

In step 544, the CPU 102 determines whether or not the button determined in step 540 to have been selected is the “Administrator Login” button 2930. If it is determined that the button is the “Administrator Login” button 2930, the control proceeds to step 546. Otherwise, the control proceeds to step 520.

If the “One-Time Authorized Permission” button 2924 has been selected (NO in step 520), the processing of steps 522 and 524 is executed, and printing is performed. If the “Prohibition” button 2926 has been selected (YES in step 520), the processing of step 526 is executed, and the print job is canceled without being printed.

On the other hand, if the “Administrator Login” button 2930 has been selected, in step 546, the CPU 102 displays a login screen and performs known login authentication. The login authentication is performed by, for example, login with a login ID and a password entered.

If the login authentication is successful, in step 548, the CPU 102 displays a selection screen on the operation unit 116. For example, as in the fourth embodiment, the screen 2400 illustrated in FIG. 24 is displayed. After displaying a screen, the CPU 102 obtains the current time from the timer, and stores the current time in the RAM 106 as the start time. The start time is used for determination in step 514 as to whether or not a predetermined time period has elapsed.

If the “Always Authorized Permission” button 2404 has been selected on the screen 2400 (FIG. 24) (YES in step 516), the user ID received in step 500 is registered to the print permission list (step 532), and printing is performed (step 524). If the “Prohibition” button 2408 has been selected (NO in step 516 and YES in step 520), the processing of step 526 is executed, and the print job is canceled without being printed. If the “One-Time Authorized Permission” button 2406 has been selected (NO in step 516 and NO in step 520), the processing of steps 522 and 524 is executed, and printing is performed.

Accordingly, upon receipt of a print job together with a user ID not registered in the print permission list (NO in step 530), the image forming apparatus 100 can suspend the print job and perform processing in accordance with instructions.

When the screen 2820 (FIG. 28) is displayed on a terminal device immediately after the user gives printing instructions by using the terminal device, the user goes to the image forming apparatus 100 and selects the “One-Time Authorized Permission” button 2924 on the screen 2920 (FIG. 29) so that printing can be performed. If the user has given printing instructions by mistake, the user can select the “Prohibition” button 2926 to stop printing.

In the case of a print request from outside the organization that manages the image forming apparatus 100 (for example, in the case where instructions for printing a huge number of prints have been issued with malicious intent), a person who has made the print request will not be able to operate the screen 2920 displayed on the image forming apparatus 100 and the print job is canceled with the lapse of a predetermined time period, thereby preventing the execution of unwanted printing. Since a message is also transmitted to the administrator computer (step 510), the execution of unwanted printing can also be prevented by the administrator's selection of the “Prohibition” button 2926.

Pre-registration in the print permission list is not necessarily required. The selection of the “Always Authorized Permission” button 2404 on the screen 2400 (FIG. 24) displayed after the administrator's administrator login facilitates the registration of a user ID for which printing is permitted, if necessary. Since only the administrator can select the “Always Authorized Permission” button 2404, inadvertent registration of a user ID to the print permission list can be prevented.

In the foregoing description, the screen 2400 illustrated in FIG. 24 is displayed when the “Administrator Login” button 2930 is selected and login authentication is successful. However, this is merely an example. For example, a screen 3140 illustrated in FIG. 31 may be displayed. The screen 3140 has an area 3102 in which a message indicating the suspension of the execution of the print job is displayed, and buttons 3144 and 3146 below the area 3102 for selecting how the print job is to be processed. Since only two buttons, namely, the “Always Authorized Permission” button 3144 and the “Prohibition” button 3146, are displayed on the screen 3140 as selectable buttons, in FIG. 27, a negative result is not obtained in step 520 when a negative result is obtained in step 516.

In the foregoing description, in step 510, a message for the administrator is transmitted to the server 300. However, this is merely an example. For example, the message may be transmitted to a terminal device or mobile terminal device (such as a mobile phone or a smartphone) frequently used by the administrator.

In addition, in step 510, the message may not necessarily be transmitted to the administrator of the image forming apparatus 100. The message may be transmitted to a specific person who has privileges for the network 340.

Furthermore, the message may be presented in any way. The message may not necessarily be displayed as a screen, and may be presented via audio.

### Sixth Embodiment

In the fourth and fifth embodiments, a selection screen is displayed on an image forming apparatus to enable an operator of the image forming apparatus to select a process to be performed on a print job. In a sixth embodiment, in contrast, a process to be performed on a print job is performed by a specific person such as an administrator via a network.

A network printing system according to this embodiment, and an image forming apparatus, terminal devices, and a server that constitute the network printing system have a configuration similar to that of the first embodiment (FIGS. 1 to 4). A terminal device according to this embodiment executes a program similar to that (FIG. 21) in the fourth embodiment. A print processing program executed by the image forming apparatus is different from that in the fourth embodiment. In addition, unlike the fourth embodiment, the administrator computer executes a printing availability selection program. In the following, reference is made to the reference numerals in FIGS. 1 to 5.

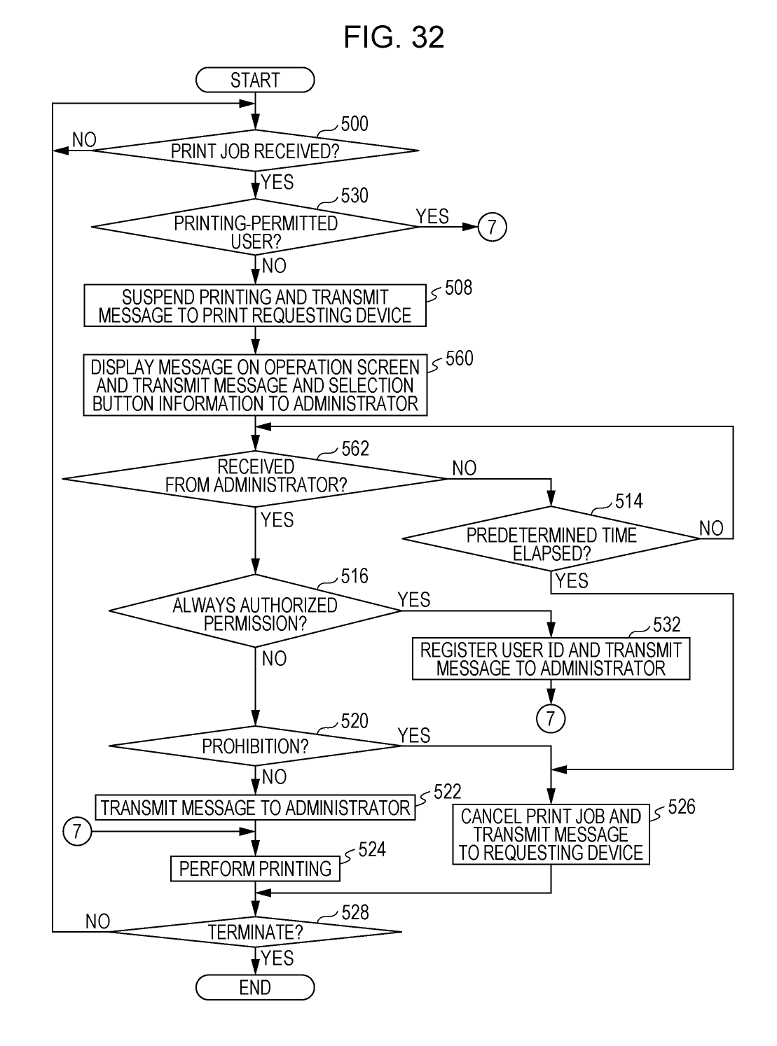

FIG. 32 illustrates a print processing program executed by the image forming apparatus 100 according to this embodiment. The flowchart illustrated in FIG. 32 is different from the flowchart illustrated in FIG. 22 only in that step 510 and step 512 are replaced with step 560 and step 562, respectively. In FIG. 32 and FIG. 22, the processes of the steps assigned the same reference numerals are substantially identical.

In the first terminal device 200 and the second terminal device 230, a print request program is executed in the way illustrated in FIG. 21, and a print request is sent to the image forming apparatus 100. In the image forming apparatus 100, similarly to the fourth embodiment, upon receipt of a print job, the CPU 102 determines whether the print request is a print request from a user for which printing is permitted (a user whose user ID has been registered in the print permission list). If the print job is a print request from a user for which printing is permitted, printing is performed.

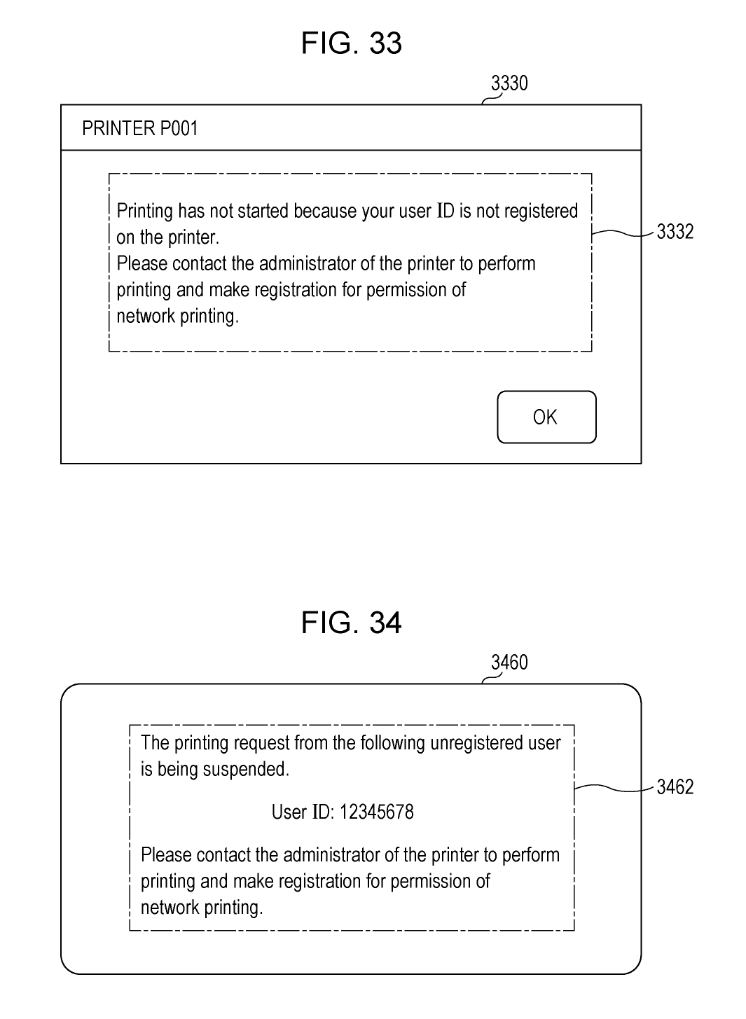

If the print job is not a print request from a registered user, in step 508, the CPU 102 suspends the execution of the received print job, and transmits a message indicating the suspension of printing to the device that has transmitted the print job because the print request is sent from an unregistered user. The message to be transmitted is different from that in the fourth embodiment, and a screen different from the screen 2300 is displayed on a display unit of the terminal device that has transmitted the print job. For example, a screen 3330 illustrated in FIG. 33 is displayed. The screen 3330 has an area 3332 in which a message indicating that printing has not started because the print request is sent from an unregistered user and a message indicating that it is necessary to contact the administrator to perform printing are displayed. When the screen 3330 is displayed on a terminal device, the user can contact the administrator of the image forming apparatus 100 to ask them to take appropriate measures.

In step 560, the CPU 102 transmits, to the administrator computer (i.e., the server 300), a message indicating the reception of a print request from an unregistered user and selection button information, and displays a screen including a similar message on the operation unit 116. Since the message for the terminal device that has transmitted the print job is different from that in the fourth embodiment, the message to be displayed on the operation unit 116 is also different from that in the fourth embodiment. For example, a screen 3460 illustrated in FIG. 34 is displayed. After displaying a screen, the CPU 102 obtains the current time from the timer, and stores the current time in the RAM 106 as the start time.

The screen 3460 has an area 3462 in which a message indicating the suspension of the execution of the print job from an unregistered user and a message indicating that it is necessary to contact the administrator to perform printing are displayed. No buttons are displayed to give instructions to process the print job.

In step 562, the CPU 102 determines whether or not instructions have been received from the administrator computer (i.e., the server 300). The possible instructions to be received are instructions for one of “always authorized permission”, “prohibition”, and “one-time authorized permission”. Specifically, the CPU 102 receives data indicating one of “always authorized permission”, “prohibition”, and “one-time authorized permission”. If it is determined that instructions have been received, the control proceeds to step 516. Otherwise, the control proceeds to step 514.

In step 514, the CPU 102 determines whether or not a predetermined time period has elapsed since the screen was displayed on the operation unit 116 in step 560. Specifically, the CPU 102 obtains the current time from the timer, reads the start time stored in the RAM 106 in step 560, and determines whether or not a predetermined time period has elapsed since the start time. If it is determined that the predetermined time period has elapsed, the CPU 102 makes the screen 3460 disappear, and then the control proceeds to step 526. Otherwise, the control returns to step 562.

In step 516, the CPU 102 determines whether or not instructions for “always authorized permission” have been received in step 562. If it is determined that instructions for “always authorized permission” have been received, the processing of step 532 is executed, the user ID received in step 500 is registered to the print permission list (or stored in the HDD 108), and a message indicating the registration of the user ID is transmitted to the administrator computer (i.e., the server 300). Thereafter, in step 524, printing is performed.

On the other hand, if instructions for “always authorized permission” have not been received, the processing of step 520 is executed, and the CPU 102 determines whether or not instructions for “prohibition” have been received in step 562. If instructions for “prohibition” have been received, the processing of step 526 is executed, and the print job received in step 500 is canceled (or deleted from the RAM 106 or the HDD 108). Then, a message indicating the cancellation of the transmitted print job is transmitted to the source of print job.

On the other hand, if instructions for “prohibition” have not been received, that is, if instructions for “one-time authorized permission” have been received, the processing of steps 522 and 524 is executed, and printing is performed.

The printing availability selection program executed by the administrator computer (i.e., the server 300) is started when the power of the server 300 is turned on. Referring to FIG. 19, in step 600 of the printing availability selection program, the CPU 302 determines whether or not a message has been received from the image forming apparatus 100. If it is determined that a message has been received, the control proceeds to step 602. Otherwise, the processing of step 600 is repeatedly performed.

In step 602, the CPU 302 displays the message received in step 600 on the display unit 312.

In step 604, the CPU 302 determines whether or not selection button information has also been received in step 600 together with the message. If it is determined that selection button information has been received, the control proceeds to step 606. Otherwise, the control proceeds to step 622.

An affirmative result is obtained in step 604 in a case where the message and selection button information transmitted from the image forming apparatus 100 in step 560 in FIG. 32 have been received. A negative result is obtained in step 604 in a case where the message transmitted from the image forming apparatus 100 in step 532 or step 522 in FIG. 32 has been received.

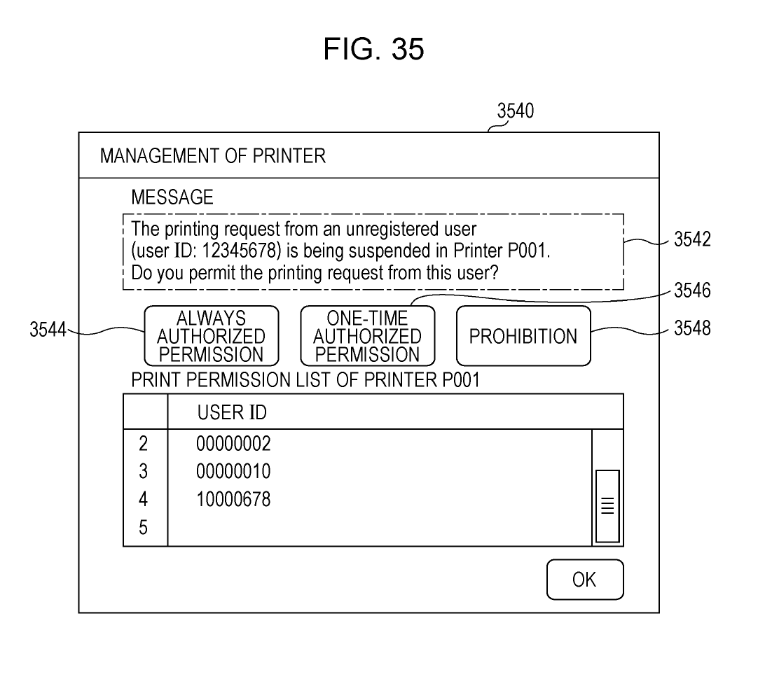

In step 606, the CPU 302 displays selection buttons on the display unit 312 in accordance with the selection button information received in step 600. For example, a screen 3540 illustrated in FIG. 35 is displayed. The screen 3540 has an area 3542 in which a message indicating the suspension of the execution of the print job from an unregistered user is displayed, and buttons 3544, 3546, and 3548 below the area 3542 for selecting how the print job is to be processed. Furthermore, user IDs for which printing from the image forming apparatus (i.e., Printer P001) is currently permitted are displayed below the selection buttons. After displaying the screen 3540, the CPU 302 obtains the current time from the timer (not illustrated in FIG. 4), and stores the current time in the RAM 306 as the start time.

In step 608, the CPU 302 determines whether or not any of the buttons 3544, 3546, and 3548 displayed on the screen 3540 illustrated in FIG. 35 has been operated (or selected). If it is determined that any button has been operated, the CPU 302 makes the screen 3540 disappear, and then the control proceeds to step 612. Otherwise, the control proceeds to step 610.

In step 610, the CPU 302 determines whether or not a predetermined time period has elapsed since the selection buttons were displayed on the display unit 312 in step 606. Specifically, the CPU 302 obtains the current time from the timer, reads the start time stored in the RAM 306 in step 606, and determines whether or not a predetermined time period has elapsed since the start time. If it is determined that the predetermined time period has elapsed, the CPU 302 makes the screen 3540 disappear, and then the control proceeds to step 620. Otherwise, the control returns to step 608.

In step 612, the CPU 302 determines whether or not the button determined in step 608 to have been selected is the “Always Authorized Permission” button 3544. If it is determined that the button is the “Always Authorized Permission” button 3544, the control proceeds to step 614. Otherwise, the control proceeds to step 616.

In step 614, the CPU 302 transmits data indicating “always authorized permission” to the image forming apparatus 100. Then, the control proceeds to step 622.

If NO is determined in step 612, in step 616, the CPU 302 determines whether or not the button determined in step 608 to have been selected is the “Prohibition” button 3548. If it is determined that the button is the “Prohibition” button 3548, the control proceeds to step 620. Otherwise, the control proceeds to step 618.

In step 618, the CPU 302 transmits data indicating “one-time authorized permission” to the image forming apparatus 100.

In step 620, the CPU 302 transmits data indicating “prohibition” to the image forming apparatus 100.

In step 622, the CPU 302 determines whether or not instructions for terminating the program have been received. If it is determined that instructions for terminating the program have been received, the program ends. Otherwise, the control returns to step 600. The termination instructions are made by, for example, turning off the power of the server 300.

Accordingly, upon receipt of a print job together with a user ID not registered in the print permission list (NO in step 530), the image forming apparatus 100 can suspend the print job, ask the administrator how the print job is to be processed (or display the screen 3540 on the server 300), and perform processing in accordance with instructions from the administrator.

When the screen 3540 (FIG. 35) is displayed on the display unit 312 of the server 300, the administrator can select the “Always Authorized Permission” button 3544 or the “One-Time Authorized Permission” button 3646, without going to the image forming apparatus 100, to perform printing. The administrator can select the “Prohibition” button 3548 to stop printing, when informed by the user that printing instructions have been given by mistake. In addition, in the case of a print request from outside the organization that manages the image forming apparatus 100 (for example, in the case where instructions for printing a huge number of prints have been issued with malicious intent), the administrator can select the “Prohibition” button 3548 to prevent unwanted printing from being performed.

Furthermore, pre-registration in the print permission list is not necessarily required. The selection of the “Always Authorized Permission” button 3544 on the displayed screen 3540 facilitates the registration of a user ID for which printing is permitted, if necessary. Moreover, only the administrator can provide instructions as to whether or not to execute a print job. Thus, inadvertent registration of a user ID to the print permission list can be prevented.

When the image forming apparatus 100 transmits a message and selection button information to the server 300 in step 560, it may be sufficient that information for allowing the server 300 to display a screen, such as the screen 3540 (FIG. 35), on the display unit 312 be transmitted, and the transmission of the message and the selection button information is optional. For example, for the message, text data of the message to be displayed in the area 3542 may be transmitted or, if the HDD 308 of the server 300 has stored therein in advance boilerplate message information, only a user ID (“12345678” in FIG. 35) may be transmitted. For the selection button information, image data of the buttons 3544 to 3548 may be transmitted, or only text information (text data) shown in the buttons 3544 to 3548 may be transmitted. If the HDD 308 of the server 300 has stored therein in advance image data of selection buttons, only code for instructions to display the selection buttons may be transmitted.

The flowcharts illustrated in FIG. 21, FIG. 22, FIG. 27, FIG. 32, and FIG. 19 according to the fourth to sixth embodiments described above may be modified, as desired, and executed. In the foregoing description, for example, in the processing steps of determining which of the three options (buttons) has been selected in the flowcharts illustrated in FIG. 22, FIG. 32, and FIG. 19, whether or not “always authorized permission” has been selected is determined first, and then whether or not “prohibition” has been selected is determined. However, this is merely an example. The processing steps for determining which of the three options has been selected may be performed in any order.

In the foregoing description, by way of example, a data file including a print job and a user ID is generated and transmitted. However, this is merely an example. A user ID may be transmitted separately from a print job. In this case, the image forming apparatus 100 can associate a print job and a user ID (a print job generated from a packet having the same source IP address, and a user ID) which are received from the same terminal device within a certain time period with each other. In order to more accurately associate the print job with the user ID, preferably, a terminal device adds information for associating the print job with the user ID to the print job or the user ID and then transmits the print job, the user ID, and the information. For example, the file name of the print job may be added to the user ID before transmission.

In the foregoing description, a terminal device transmits a login ID as information identifying a user who has given printing instructions. However, this is merely an example. An ID different from a login ID may be used. In this case, when the setting of printing conditions is accepted (for example, step 400 in FIG. 21), the input of a user ID may be accepted.

A print permission may be set using a password in addition to a user ID. In this case, both a user ID and a password are stored in the print permission list. A terminal device transmits a password in addition to a user ID. The password may be a password for login authentication to the terminal device, or may be a different password.

When transmitting a print job, a terminal device may transmit information identifying the terminal device (hereinafter also referred to as “device-identifying information”) instead of a user ID. Examples of the device-identifying information include the serial number, MAC address, and computer name of the terminal device. The serial number of the terminal device may be that managed by an operating system (OS) of the terminal device. The computer name may be a name including information on a network to which the terminal device belongs. Preferably, for example, the computer name is a host name including a domain name. In this case, device-identifying information is stored in the print permission list instead of a user ID, and device-identifying information is used instead of a user ID for the determination of whether or not printing is permitted. In addition, messages to be displayed on an image forming apparatus, a terminal device, and a server include device-identifying information instead of a user ID.

In the foregoing description, by way of example, the communication protocol is TCP/IP. However, this is merely an example.

The embodiments disclosed herein are considered to be in all respects illustrative only, and the present disclosure is not limited to the embodiments described above. The scope of the present disclosure is defined by the appended claims with reference to the detailed description of embodiments of the present disclosure, and all the changes which come within the meaning and range of equivalency of the claims are therefore intended to be embraced therein.

The present disclosure contains subject matter related to that disclosed in Japanese Priority Patent Application JP 2014-146745 filed in the Japan Patent Office on Jul. 17, 2014 and Japanese Priority Patent Application JP 2014-219432 filed in the Japan Patent Office on Oct. 28, 2014, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus comprising:
an image forming unit that forms an image on recording paper;
a receiving unit that receives, from an external device, a print job and an address of the external device via a network;
a determination unit that determines whether or not formation of an image based on the print job by using the image forming unit is permitted;
a storage unit that stores permission information for identifying a permitted address representing an address of an external device for which formation of an image based on a print job by using the image forming unit is permitted; and
an input unit that accepts an instruction, wherein
the determination unit determines whether or not formation of an image based on the print job by using the image forming unit is permitted, by determining whether or not the address of the external device, which is a source of the print job, matches the permitted address,
in response to the determination unit determining that the address of the external device, which is the source of the print job, matches the permitted address, the image forming unit forms an image based on the print job,
in response to the determination unit determining that the address of the external device, which is the source of the print job, does not match the permitted address, the input unit accepts an instruction as to whether or not to cause the image forming unit to form an image based on the print job, and
in response to the input unit having accepted an instruction for causing the image forming unit to form an image based on the print job, the image forming unit forms an image based on the print job.

2. The image forming apparatus according to claim 1, wherein
the instruction for causing the image forming unit to form an image based on the print job includes a first instruction and a second instruction,
in response to the input unit having accepted the first instruction, the storage unit stores, as the permission information, the address of the external device, which is the source of the print job, or network identification information indicating a network to which the external device belongs, and
in response to the input unit having accepted the second instruction, the storage unit does not store, as the permission information, either the address of the external device, which is the source of the print job, or the network identification information indicating the network to which the external device belongs.

3. The image forming apparatus according to claim 2, further comprising a specific information receiving unit that receives, from the external device, specific information for identifying the network identification information, wherein
in response to the input unit having accepted the first instruction, the storage unit stores network identification information that is identified by using the specific information.

4. The image forming apparatus according to claim 3, further comprising a request transmitting unit that, in response to the determination unit determining that the address of the external device, which is the source of the print job, does not match the permitted address, transmits to the external device a request for transmission of the specific information.

5. The image forming apparatus according to claim 1, further comprising a print job storage unit that stores the print job, wherein
the instruction to be input to the input unit includes a prohibition instruction for prohibiting formation of an image based on the print job, and
in response to the input unit having accepted the prohibition instruction, the image forming unit does not form an image based on the print job and the print job storage unit cancels the print job.

6. The image forming apparatus according to claim 1, further comprising a unit that, in response to the determination unit determining that the address of the external device, which is the source of the print job, does not match the permitted address, suspends formation of an image based on the print job and transmits information indicating suspension of formation of an image based on the print job to the external device that has transmitted the print job.

7. The image forming apparatus according to claim 1, further comprising a display unit that, in response to the determination unit determining that the address of the external device, which is the source of the print job, does not match the permitted address, displays a screen including a button with which to give the input unit an instruction as to whether or not to cause the image forming unit to form an image based on the print job.

8. The image forming apparatus according to claim 1, further comprising a unit that, in response to the determination unit determining that the address of the external device, which is the source of the print job, does not match the permitted address, transmits, to a device used by an administrator of the image forming apparatus, information for forming a screen including a button with which to give an instruction as to whether or not to cause the image forming unit to form an image based on the print job, wherein
the input unit accepts the instruction by receiving, from the device used by the administrator, information indicating that the button has been operated.

9. An image forming apparatus comprising:
an image forming unit that forms an image on recording paper;
a receiving unit that receives a print job from an external device via a network;
a determination unit that determines whether or not formation of an image based on the print job by using the image forming unit is permitted, in accordance with a network to which the external device belongs;
a storage unit that stores permission information which identifies a network for which formation of an image based on a print job by using the image forming unit is permitted;
a network identifying unit that identifies network identification information indicating a network to which the external device belongs; and
an input unit that accepts an instruction, wherein
the determination unit determines whether or not formation of an image based on the print job by using the image forming unit is permitted, by determining whether or not the network identification information identified by the network identifying unit is included in the permission information,
in response to the determination unit determining that the network identification information is included in the permission information, the image forming unit forms an image based on the print job,
in response to the determination unit determining that the network identification information is not included in the permission information, the input unit accepts an instruction as to whether or not to cause the image forming unit to form an image based on the print job, and
in response to the input unit having accepted an instruction for causing the image forming unit to form an image based on the print job, the image forming unit forms an image based on the print job.

10. The image forming apparatus according to claim 9, further comprising a specific information receiving unit that receives, from the external device, specific information for identifying the network to which the external device belongs, wherein
the determination unit identifies the network identification information by using the specific information.

11. The image forming apparatus according to claim 10, further comprising a request transmitting unit that, in response to the determination unit determining that the network identification information is not included in the permission information, transmits to the external device a request for transmission of the specific information.

12. The image forming apparatus according to claim 9, wherein
the instruction for causing the image forming unit to form an image based on the print job includes a first instruction and a second instruction,
in response to the input unit having accepted the first instruction, the storage unit stores the network identification information as the permission information, and
in response to the input unit having accepted the second instruction, the storage unit does not store the network identification information as the permission information.

13. The image forming apparatus according to claim 9, further comprising a print job storage unit that stores the print job, wherein
the instruction to be input to the input unit includes a prohibition instruction for prohibiting formation of an image based on the print job, and
in response to the input unit having accepted the prohibition instruction, the image forming unit does not form an image based on the print job and the print job storage unit cancels the print job.

14. The image forming apparatus according to claim 9, further comprising a unit that, in response to the determination unit determining that the network identification information is not included in the permission information, suspends formation of an image based on the print job and transmits information indicating suspension of formation of an image based on the print job to the external device that has transmitted the print job.

15. The image forming apparatus according to claim 9, further comprising a display unit that, in response to the determination unit determining that the network identification information is not included in the permission information, displays a screen including a button with which to give the input unit an instruction as to whether or not to cause the image forming unit to form an image based on the print job.

16. The image forming apparatus according to claim 9, further comprising a unit that, in response to the determination unit determining that the network identification information is not included in the permission information, transmits, to a device used by an administrator of the image forming apparatus, information for forming a screen including a button with which to give an instruction as to whether or not to cause the image forming unit to form an image based on the print job, wherein
the input unit accepts the instruction by receiving, from the device used by the administrator, information indicating that the button has been operated.

17. The image forming apparatus according to claim 9, wherein
the permission information includes an address of an external device for which formation of an image by using the image forming unit is permitted,
the receiving unit receives an address of the external device, which is a source of the print job,
the determination unit determines whether or not formation of an image based on the print job by using the image forming unit is permitted, by determining whether or not the address of the external device, which is the source of the print job, is included in the permission information, in response to the determination unit determining that the address of the external device, which is the source of the print job, is included in the permission information, the image forming unit forms an image based on the print job,
in response to the determination unit determining that the address of the external device, which is the source of the print job, is not included in the permission information, the input unit accepts an instruction as to whether or not to cause the image forming unit to form an image based on the print job, and
in response to the input unit having accepted an instruction for causing the image forming unit to form an image based on the print job, the image forming unit forms an image based on the print job.

18. A network system comprising:
an image forming apparatus; and
a terminal device, the image forming apparatus and the terminal device being connected to a network,
the image forming apparatus including
an image forming unit that forms an image on recording paper,
a receiving unit that receives, from the terminal device, a print job and an address of the terminal device via the network,
a determination unit that determines whether or not formation of an image based on the print job by using the image forming unit is permitted,
a storage unit that stores permission information for identifying a permitted address representing an address of a terminal device for which formation of an image based on a print job by using the image forming unit is permitted, and
an input unit that accepts an instruction, wherein
the determination unit determines whether or not formation of an image based on the print job by using the image forming unit is permitted, by determining whether or not the address of the terminal device, which is a source of the print job, matches the permitted address,
in response to the determination unit determining that the address of the terminal device, which is the source of the print job, matches the permitted address, the image forming unit forms an image based on the print job,
in response to the determination unit determining that the address of the terminal device, which is the source of the print job, does not match the permitted address, the input unit accepts an instruction as to whether or not to cause the image forming unit to form an image based on the print job, and
in response to the input unit having accepted an instruction for causing the image forming unit to form an image based on the print job, the image forming unit forms an image based on the print job.

19. A network system comprising:
an image forming apparatus; and
a terminal device, the image forming apparatus and the terminal device being connected to a network,
the image forming apparatus including
an image forming unit that forms an image on recording paper,
a receiving unit that receives a print job from the terminal device via the network,
a determination unit that determines whether or not formation of an image based on the print job by using the image forming unit is permitted, in accordance with a network to which the terminal device belongs,
a storage unit that stores permission information which identifies a network for which formation of an image based on a print job by using the image forming unit is permitted,
a network identifying unit that identifies network identification information indicating a network to which the terminal device belongs, and
an input unit that accepts an instruction, wherein
the determination unit determines whether or not formation of an image based on the print job by using the image forming unit is permitted, by determining whether or not the network identification information identified by the network identifying unit is included in the permission information,
in response to the determination unit determining that the network identification information is included in the permission information, the image forming unit forms an image based on the print job,
in response to the determination unit determining that the network identification information is not included in the permission information, the input unit accepts an instruction as to whether or not to cause the image forming unit to form an image based on the print job, and
in response to the input unit having accepted an instruction for causing the image forming unit to form an image based on the print job, the image forming unit forms an image based on the print job.
